(19) United States
(12) Patent Application Publication
(10) Pub. No.: US 2019/0007585 A1
(43) Pub. Date: Jan. 3, 2019

(54) INSTALLATION POSITION DETERMINING DEVICE, INSTALLATION POSITION DETERMINING METHOD, AND COMPUTER READABLE MEDIUM

(71) Applicant: MITSUBISHI ELECTRIC CORPORATION, Tokyo (JP)

(72) Inventors: Kohei OKAHARA, Tokyo (JP); Ichiro FURUKI, Tokyo (JP); Tsukasa FUKASAWA, Tokyo (JP); Kento YAMAZAKI, Tokyo (JP)

(73) Assignee: MITSUBISHI ELECTRIC CORPORATION, Tokyo (JP)

(21) Appl. No.: 16/061,768

(22) PCT Filed: Jan. 10, 2017
(86) PCT No.: PCT/JP2017/000512

§ 371 Date: Jun. 13, 2018

(30) Foreign Application Priority Data
Feb. 4, 2016 (JP) PCT/JP2016/053309

(51) Int. Cl. H04N 5/222; H04N 5/247; G06T 7/70

(52) U.S. Cl. CPC H04N 5/2224; G06T 7/70; H04N 5/247

(57) ABSTRACT

A position specifying unit specifies installation positions of cameras at which a subject region received by a region receiving unit can be captured on the basis of a camera condition received by the condition receiving unit. A virtual video generating unit generates virtual captured videos obtained by capturing a CG space with the cameras in a case where the cameras are installed at the specified installation positions, and performs overhead-conversion on the generated virtual captured videos and combines the virtual captured videos to generate a virtual synthetic video. A display unit displays the generated virtual synthetic video on a display.

### TECHNICAL FIELD

The present invention relates to a technology for determining installation positions of a plurality of cameras in creating a video of a subject range by combining videos captured by the cameras.

### BACKGROUND ART

Patent Literatures 1 to 3 disclose camera installation simulators to simulate a virtual captured video from a camera for assisting installation of surveillance cameras. Such a camera installation simulator creates a three-dimensional model space of a facility in which a surveillance camera is to be installed by using a map image of the facility and three-dimensional models of vehicles, obstacles, and the like. The camera installation simulator then simulates a coverage range, a blind range, and a captured image when a camera is installed at a specified position within the space in a particular orientation.

### CITATION LIST

### Patent Literature

Patent Literature 1: JP 2009-105802 A

Patent Literature 2: JP 2009-239821 A

Patent Literature 3: JP 2009-217115 A

### SUMMARY OF INVENTION

### Technical Problem

The camera installation simulators disclosed in Patent Literatures 1 to 3 simulate a captured range and how a captured video looks when a camera is installed at a particular position in a particular orientation. Thus, for monitoring a particular region, a user needs to find an optimum camera installation position where the entire subject region can be captured by changing the installation condition of the camera.

In addition, the camera installation simulators disclosed in Patent Literatures 1 to 3 are based on the assumption of a single camera, but are not based on consideration of determining optimum arrangement of a plurality of cameras for creating a synthetic video from a plurality of camera images. Thus, how a video obtained by combining videos from a plurality of cameras looks cannot be known.

An object of the present invention is to enable simple determination of installation positions of a plurality of cameras, which allows a video of a subject region desired by a user to be obtained by combining videos captured by the cameras.

### Solution to Problem

An installation position determining device according to the present invention includes:

a condition receiving unit to receive input of a camera condition indicating capturing conditions of cameras;

a position specifying unit to specify installation positions of cameras at which a subject region can be captured according to the camera condition received by the condition receiving unit; and

a virtual video generating unit to generate virtual captured videos obtained by capturing a virtual model with the cameras in a case where the cameras are installed at the installation positions specified by the position specifying unit, and perform overhead-view conversion on the generated virtual captured videos and combine the virtual captured videos to generate a virtual synthetic video.

### Advantageous Effects of Invention

According to the present invention, the installation positions of a plurality of cameras at which the plurality of cameras can capture a subject region are specified, the number of cameras being equal to or smaller than a number indicated by a camera condition, and a virtual synthetic video in a case where the cameras are installed at the specified installation positions is generated. This allows the user to determine the installation positions of the cameras where a desired video can be obtained only by checking the virtual synthetic video while changing the camera condition.

### BRIEF DESCRIPTION OF DRAWINGS

FIG. 1 is a configuration diagram of an installation position determining device 10 according to a first embodiment.

FIG. 2 is a flowchart illustrating operation of the installation position determining device 10 according to the first embodiment.

FIG. 3 is a diagram illustrating a top view 44 of a CG space 43 according to the first embodiment as viewed from above.

FIG. 4 is a diagram illustrating example display of the display unit 25 according to the first embodiment.

FIG. 5 is a flowchart of step S3 according to the first embodiment.

FIG. 6 is a diagram illustrating example installation of cameras 50 according to the first embodiment.

FIG. 7 is a diagram illustrating a coverage range H of a camera 50 according to the first embodiment.

FIG. 8 is a diagram illustrating a coverage range H of a camera 50 according to the first embodiment.

FIG. 9 is a diagram explaining elongation when a tall subject is captured according to the first embodiment.

FIG. 10 is a diagram explaining a use range Hk* according to the first embodiment.

FIG. 11 is a diagram explaining subjects behind cameras 50 according to the first embodiment.

FIG. 12 is a diagram explaining subjects behind cameras 50 according to the first embodiment.

FIG. 13 is a top view of a coverage range of a camera 50 according to the first embodiment.

FIG. 14 is a diagram illustrating example installation of cameras 50 in a y direction according to the first embodiment.

FIG. 15 is a flowchart of step S5 according to the first embodiment.

FIG. 16 is a diagram explaining a capturing plane 52 according to the first embodiment.

FIG. 17 is a diagram illustrating a video on the capturing plane 52 and a video projected on a plane according to the first embodiment.

FIG. 18 is a diagram illustrating a discarded part of an overhead-view video according to the first embodiment.

FIG. 19 is a diagram explaining a blending according to the first embodiment.

FIG. 20 is a configuration diagram of an installation position determining device 10 according to a first modification.

FIG. 21 is a diagram explaining a case where a subject region 42 is a circular region according to a third modification.

FIG. 22 is a diagram explaining the case where the subject region 42 is a circular region according to the third modification.

FIG. 23 is a diagram explaining a case where cameras 50 are arranged at a central position according to the third modification.

FIG. 24 is a diagram explaining a case where the subject region 42 is a region of an L shape according to the third modification.

FIG. 25 is a diagram explaining the case where the subject region 42 is a region of an L shape according to the third modification.

FIG. 26 is a diagram explaining arrangement of cameras 50 according to a fourth modification.

FIG. 27 is a diagram illustrating arrangement of cameras 50 according to the fourth modification.

FIG. 28 is a diagram illustrating arrangement of cameras 50 according to the fourth modification.

FIG. 29 is a diagram explaining a method for determining installation positions of cameras 50 according to the fourth modification.

FIG. 30 is a diagram explaining arrangement of cameras 50 according to the fourth modification.

FIG. 31 is a diagram explaining arrangement of cameras 50 according to the fourth modification.

FIG. 32 is a diagram explaining a 360-degree camera according to a fifth modification.

FIG. 33 is a diagram explaining a 360-degree camera according to the fifth modification.

FIG. 34 is a diagram for explaining arrangement of 360-degree cameras according to the fifth modification.

FIG. 35 is a diagram explaining an unusable range 47 according to a second embodiment.

FIG. 36 is a diagram explaining a method for determining installation positions of cameras 50 according to the second embodiment.

FIG. 37 is a diagram explaining a method for determining installation positions of cameras 50 according to the second embodiment.

FIG. 38 is a diagram illustrating an example of a subject region 42 according to a sixth modification.

FIG. 39 is a diagram explaining a method for determining installation positions of cameras 50 and mobile cameras 53 according to the sixth modification.

FIG. 40 is a diagram explaining a method for determining installation positions of cameras 50 according to a third embodiment.

FIG. 41 is a diagram explaining a method for determining installation positions of cameras 50 according to the third embodiment.

### DESCRIPTION OF EMBODIMENTS

### First Embodiment

***Description of Configuration***

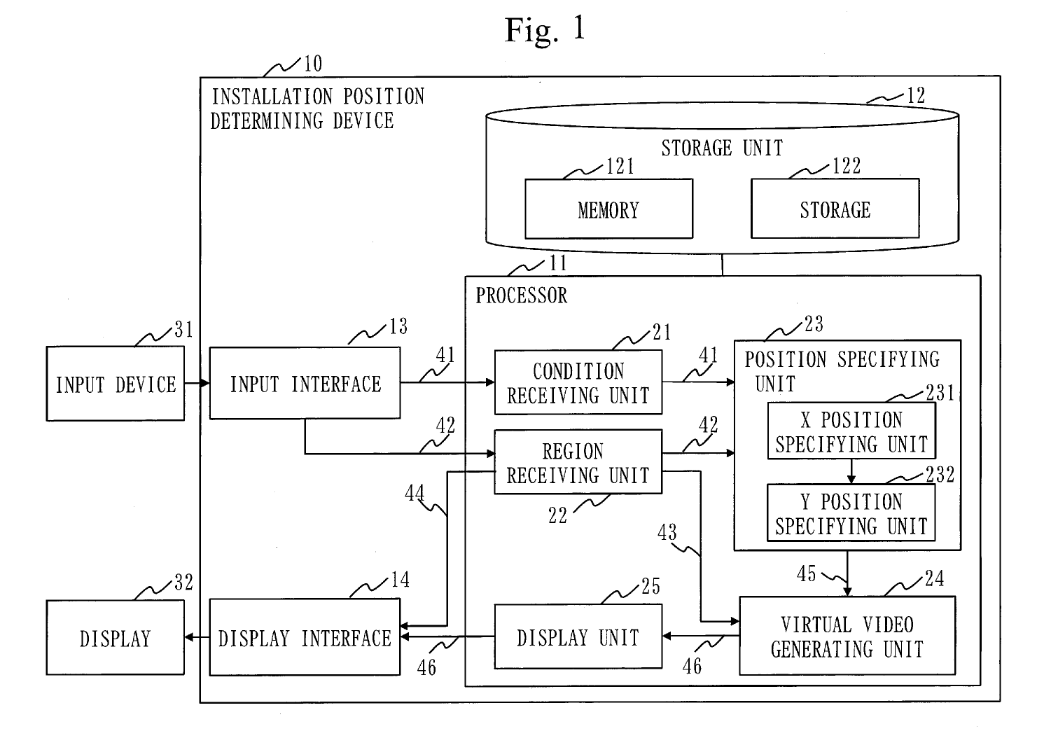

A configuration of an installation position determining device 10 according to a first embodiment will be described with reference to FIG. 1.

The installation position determining device 10 is a computer.

The installation position determining device 10 includes a processor 11, a storage unit 12, an input interface 13, and a display interface 14. The processor 11 is connected to other hardware components via a signal line, and controls these hardware components.

The processor 11 is an integrated circuit (IC) to perform processing. Specifically, the processor 11 is a central processing unit (CPU), a digital signal processor (DSP), or a graphics processing unit (GPU).

The storage unit 12 includes a memory 121 and a storage 122. Specifically, the memory 121 is a random access memory (RAM). Specifically, the storage 122 is a hard disk drive (HDD). Alternatively, the storage 122 may be a portable storage medium such as a Secure Digital (SD) memory card, a CompactFlash (CF), an NAND flash, a flexible disk, an optical disk, a compact disk, a Blu-ray (registered trademark) disk, or a DVD.

The input interface 13 is a unit to which an input device 31 such as a keyboard, a mouse, or a touch panel is connected. Specifically, the input interface 13 is a connector such as a universal serial bus (USB), IEEE 1394, or PS/2.

The display interface 14 is a unit for connecting a display 32. Specifically, the display interface 14 is a connector such as a high-definition multimedia interface (HDMI: registered trademark) or a digital visual interface (DVI).

The installation position determining device 10 includes, as functional components, a condition receiving unit 21, a region receiving unit 22, a position specifying unit 23, a virtual video generating unit 24, and a display unit 25. The position specifying unit 23 includes an X position specifying unit 231 and a Y position specifying unit 232. The functions of the condition receiving unit 21, the region receiving unit 22, the position specifying unit 23, the X position specifying unit 231, the Y position specifying unit 232, the virtual video generating unit 24, and the display unit 25 are implemented by software.

The storage 122 of the storage unit 12 stores programs to implement the functions of the respective units of the installation position determining device 10. The programs are read by the processor 11 into the memory 121, and executed by the processor 11. In this manner, the functions of the respective units of the installation position determining device 10 are implemented. In addition, the storage 122 stores map data of regions including a subject region 42 of which a virtual synthetic video 46 is to be acquired.

Information, data signal values, and variable values representing results of processing of the functions of the respective units implemented by the processor 11 are stored in the memory 121, or in a register or a cache memory in the processor 11. In the description below, the information, data, signal values, and variable values representing the results of processing of the functions of the respective units implemented by the processor 11 are assumed to be stored in the memory 121.

The programs to implement the functions implemented by the processor 11 are assumed to be stored in the storage unit 12. The programs, however, may be stored in a portable storage medium such as a magnetic disk, a flexible disk, an optical disk, a compact disk, a Blu-ray (registered trademark) disk, or a DVD.

In FIG. 1, only one processor 11 is illustrated. The number of processors 11 may, however, be more than one, and a plurality of processors 11 may execute the programs to implement the respective functions in cooperation with one another.

***Description of Operation***

Operation of the installation position determining device 10 according to the first embodiment will be explained with reference to FIGS. 1 to 19.

The operation of the installation position determining device 10 according to the first embodiment corresponds to an installation position determining method according to the first embodiment. In addition, the operation of the installation position determining device 10 according to the first embodiment corresponds to processes of an installation position determining program according to the first embodiment.

An outline of the operation of the installation position determining device 10 according to the first embodiment will be explained with reference to FIGS. 1 to 4.

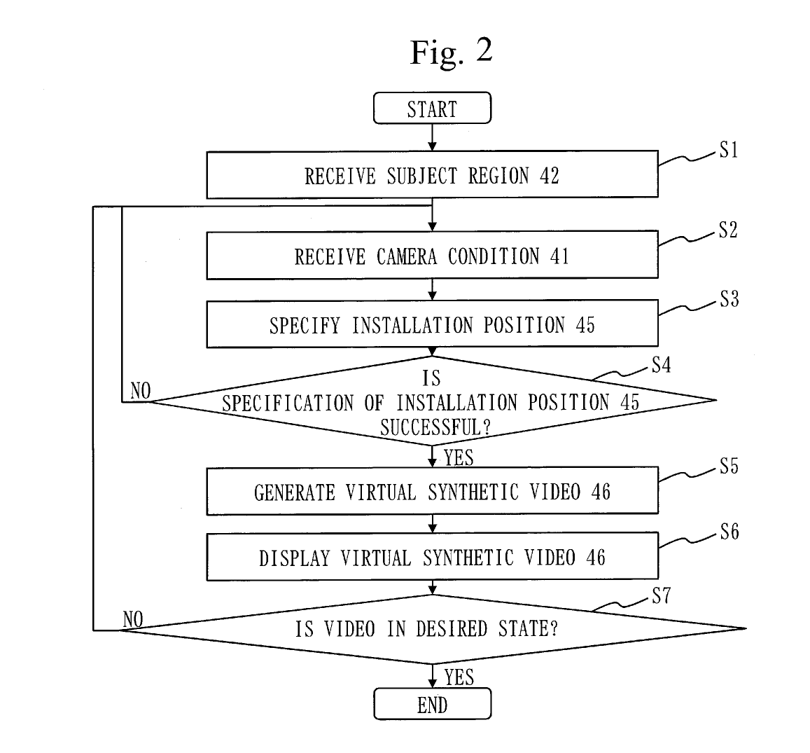

As illustrated in FIG. 2, the operation of the installation position determining device 10 is divided into steps S1 to S7.

<Step S1: Region Receiving Process>

The region receiving unit 22 receives input of a subject region 42 of which a virtual synthetic video 46 is to be acquired.

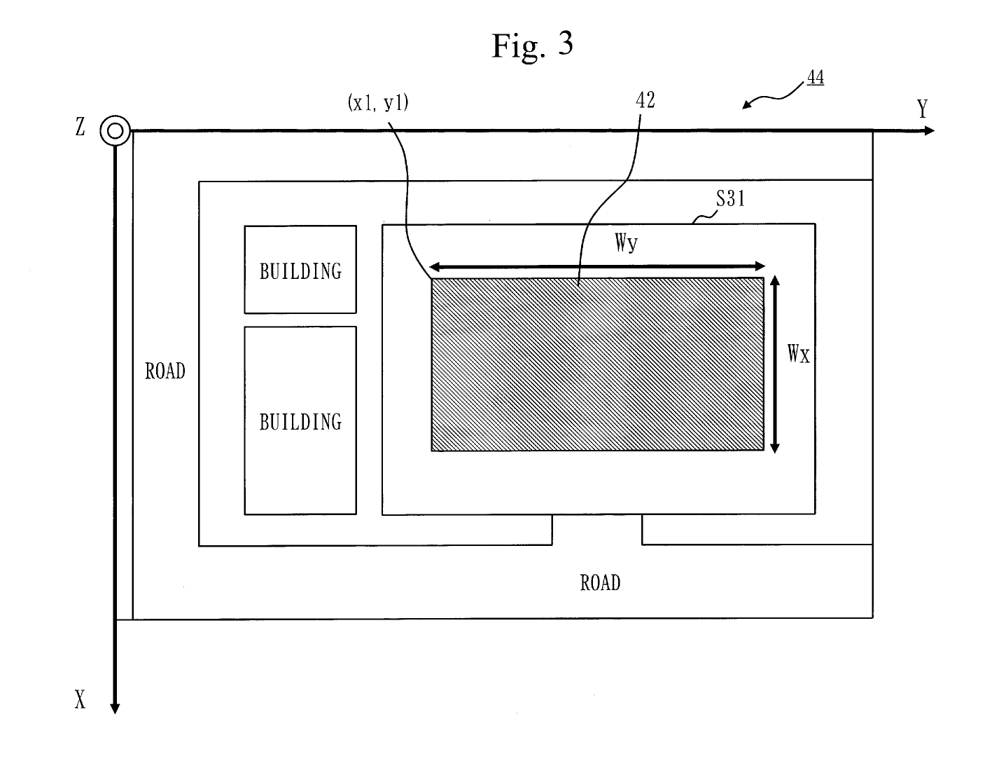

Specifically, the region receiving unit 22 reads the map data from the storage 122, and performs texture mapping and the like to generate a two-dimensional or three-dimensional computer graphics (CG) space 43. As illustrated in FIG. 3, the region receiving unit 22 displays a top view 44 of the generated CG space 43 on the display 32 via the display interface 14. A region within the top view 44 is then specified by a user through the input device 31, and the region receiving unit 22 thus receives a subject region 42. The region receiving unit 22 writes the generated CG space 43 and the received subject region 42 into the memory 121.

In the first embodiment, the CG space 43 is assumed to be a three-axis space expressed by X, Y, and Z axes. In addition, the subject region 42 is assumed to be a rectangle with sides parallel to an X axis and a Y axis on a plane expressed by the X and Y axes. Furthermore, the subject region 42 is assumed to be specified by upper-left coordinate values (x1, y1), a width Wx in an x direction parallel to the X axis, and a width Wy in a y direction parallel to the Y axis. In FIG. 3, a hatched part is assumed to be specified as the subject region 42.

<Step S2: Condition Receiving Process>

The condition receiving unit 21 receives input of a camera condition 41.

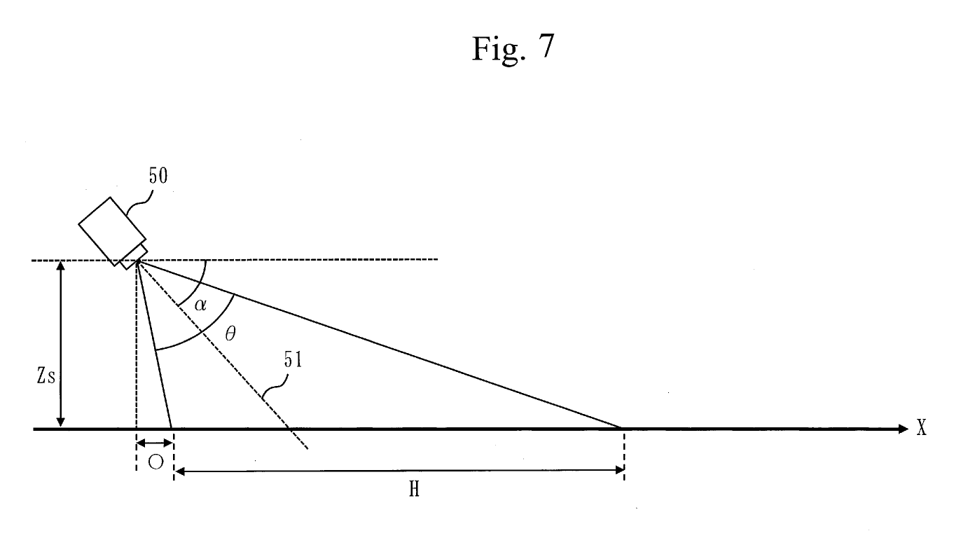

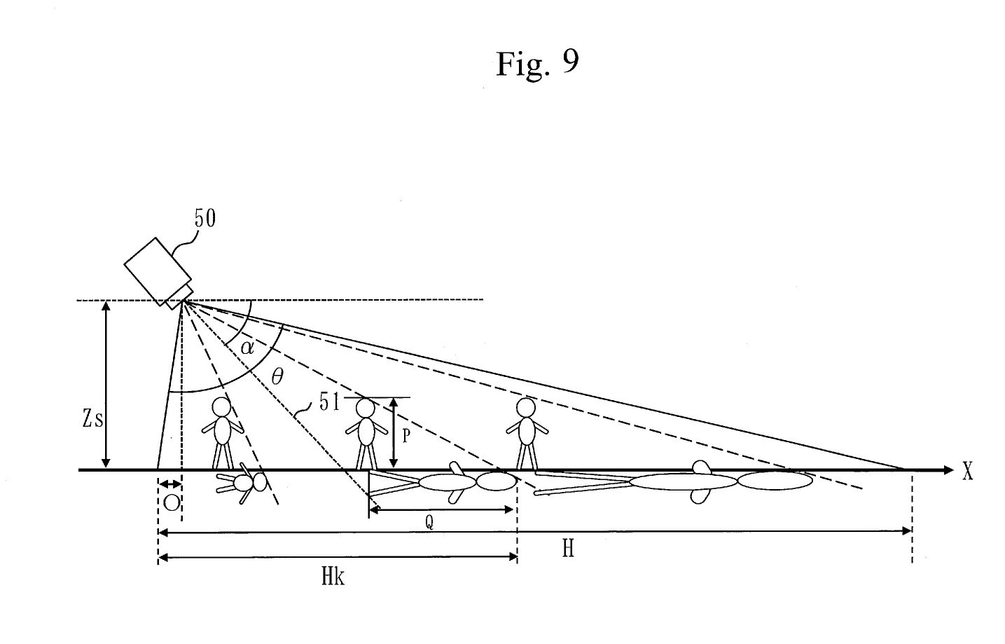

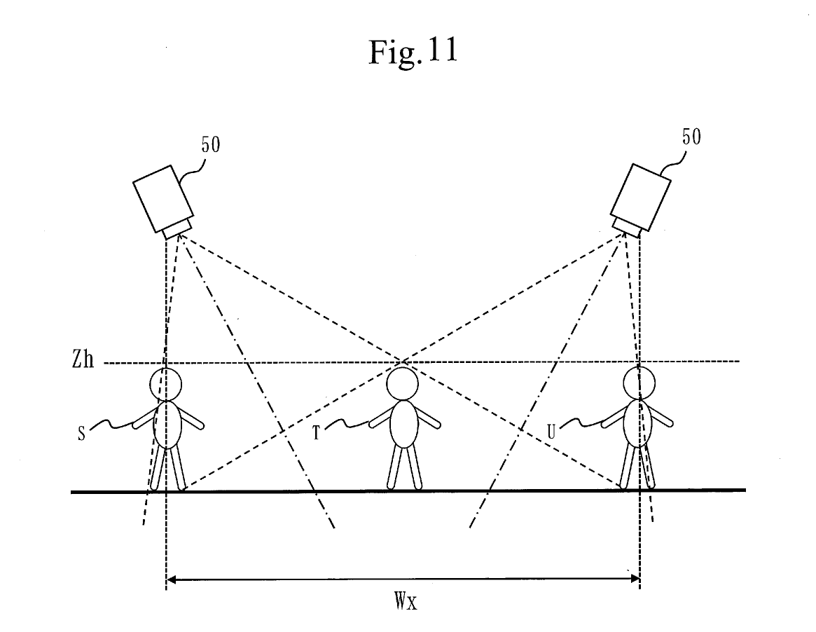

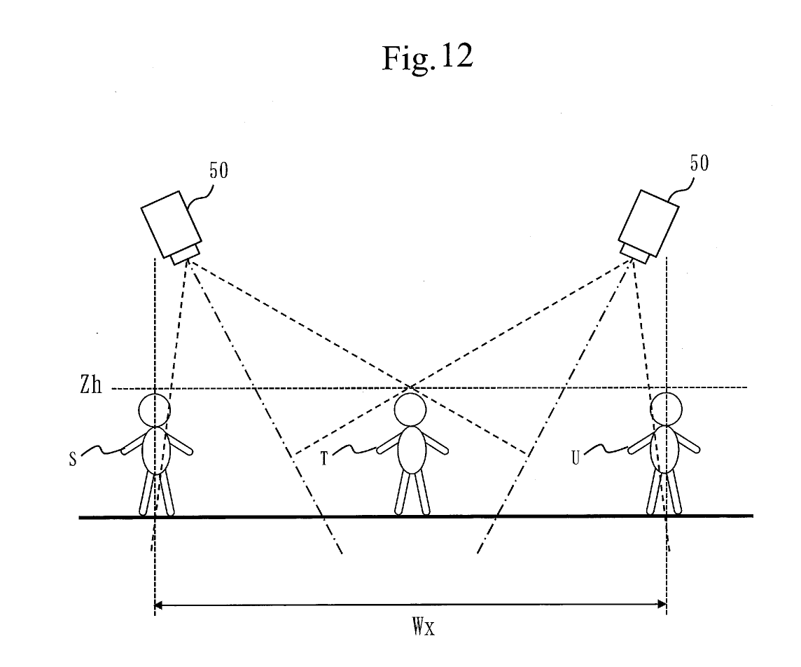

Specifically, the camera condition 41, which indicates information such as the maximum number 2N of cameras 50 to be installed, a critical elongation ratio K, a critical height Zh, an installation height Zs, an angle of view θ, a resolution, and the types of the cameras 50, is input by the user through the input device 31, and the condition receiving unit 21 receives the input camera condition 41. The critical elongation ratio K is an upper limit of an elongation ratio (Q/P) of a subject in overhead-view conversion of video (see FIG. 9). The critical height Zh is an upper limit of the height of the subject (see FIGS. 11 and 12). The installation height Zs is a lower limit of the height at which each of the cameras 50 is installed (see FIG. 7). The angle of view θ is an angle representing a range covered by a video captured by each of the cameras 50 (see FIG. 7). Note that, as will be described later, the cameras 50 are installed to face one another in the first embodiment. Thus, since the number of cameras is an even number, the maximum number of cameras 50 is represented by 2N.

In the first embodiment, the condition receiving unit 21 displays a GUI screen on the input device 31 via the display interface 14 to prompt the user to input the respective items indicated by the camera condition 41 by selecting the items or the like. The condition receiving unit 21 writes the received camera condition 41 into the memory 121.

For the cameras type, the condition receiving unit 21 displays a list of the types of the cameras 50 to prompt the user to select the camera type. In addition, for the angle of view, the condition receiving unit 21 displays the maximum angle of view and the minimum angle of view of the cameras 50 of the selected type to prompt input of an angle of view between the maximum angle of view and the minimum angle of view.

Note that the installation height Zs is specified to the lowest position within the height at which the cameras 50 can be installed. The cameras 50 are installed at a position at a certain height, such as on a pole located near the subject region 42.

<Step S3: Position Specifying Process>

The position specifying unit 23 specifies the installation positions 45 of the respective cameras 50 at which the cameras 50 can capture a subject at a height equal to or lower than the critical height Zh in the subject region 42, the number of cameras 50 being equal to or smaller than the number 2N indicated by the camera condition 41 received by the condition receiving unit 21 in step S2. When video is subjected to overhead-view conversion by the virtual video generating unit 24 in step S5, the position specifying unit 23 specifies installation positions 45 at which the elongation ratio of the subject at the critical height Zh or lower in the subject region 42 is equal to or lower than the critical elongation ratio K.

<Step S4: Specification Determining Process>

The position specifying unit 23 advances the processing to step S5 if the installation positions 45 are specified in step S3, or returns the processing to step S2 and prompts re-entry of the camera condition 41 if the installation positions 45 cannot be specified.

A case in which the installation positions 45 cannot be specified refers to a case in which installation positions 45 at which the subject region 42 can be captured with the number of cameras being equal or smaller than 2N indicated by the camera condition 41 cannot be specified or a case in which installation positions 45 at which the elongation ratio of the subject is equal to or lower than the critical elongation ratio K cannot be specified.

<Step S5: Virtual Video Generating Process>

The virtual video generating unit 24 generates virtual captured videos obtained by capturing a virtual model with the cameras 50 in a case where the cameras 50 are installed at the installation positions 45 specified by the position specifying unit 23 in step S4. The virtual video generating unit 24 then performs overhead-view conversion on the generated virtual captured videos and combines the converted virtual captured videos to generate a virtual synthetic video 46.

In the first embodiment, the CG space 43 generated in step S1 is used as the virtual model.

<Step S6: Displaying Process>

The display unit 25 displays the virtual synthetic video 46 generated by the virtual video generating unit 24 in step S5 on the display 32 via the display interface 14. This allows the user to check whether or not the obtained video is in a desired state on the basis of the virtual synthetic video 46.

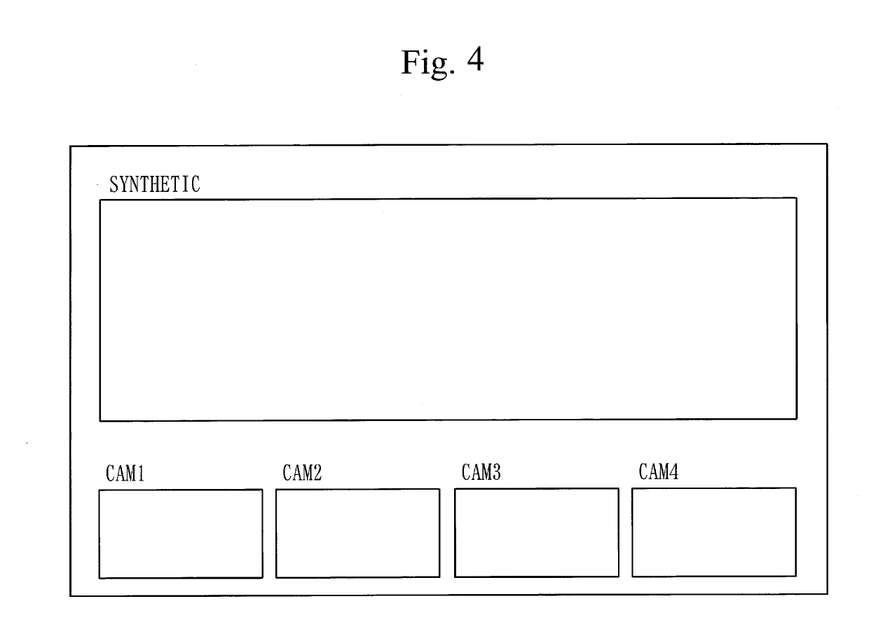

Specifically, the display unit 25 displays the virtual synthetic video 46 generated in step S5 and the virtual captured videos captured by the respective cameras 50 as illustrated in FIG. 4. In FIG. 4, the virtual synthetic video 46 is displayed in a rectangular area SYNTHETIC and the virtual captured videos of the respective cameras 50 are displayed in rectangular areas CAM1 to CAM4. A numerical value input box or a scroll bar allowing changes in the camera condition 41, such as the critical elongation ratio K of the subject, the angle of view θ to be used, and the installation height Zs, may be provided on a display window. This facilitates recognition of a change in the installation positions 45 or a change in how the virtual synthetic video 46 looks when the user has changed the camera condition 41.

<Step 7: Quality Determining Process>

According to the user's operation, the processing is terminated if the obtained video is in the desired state, or the processing is returned to step S2 for re-entry of the camera condition 41 if the obtained video is not in the desired state.

Step S3 according to the first embodiment will be explained with reference to FIGS. 1, and 3 to 14.

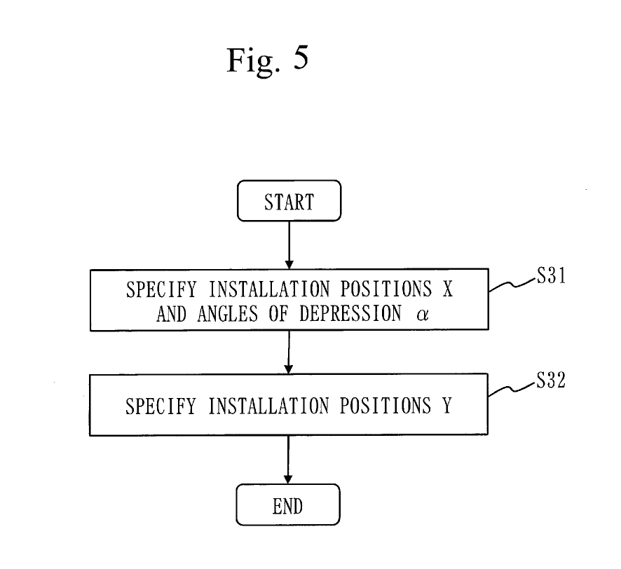

As illustrated in FIG. 5, step S3 is divided into steps S31 to S32.

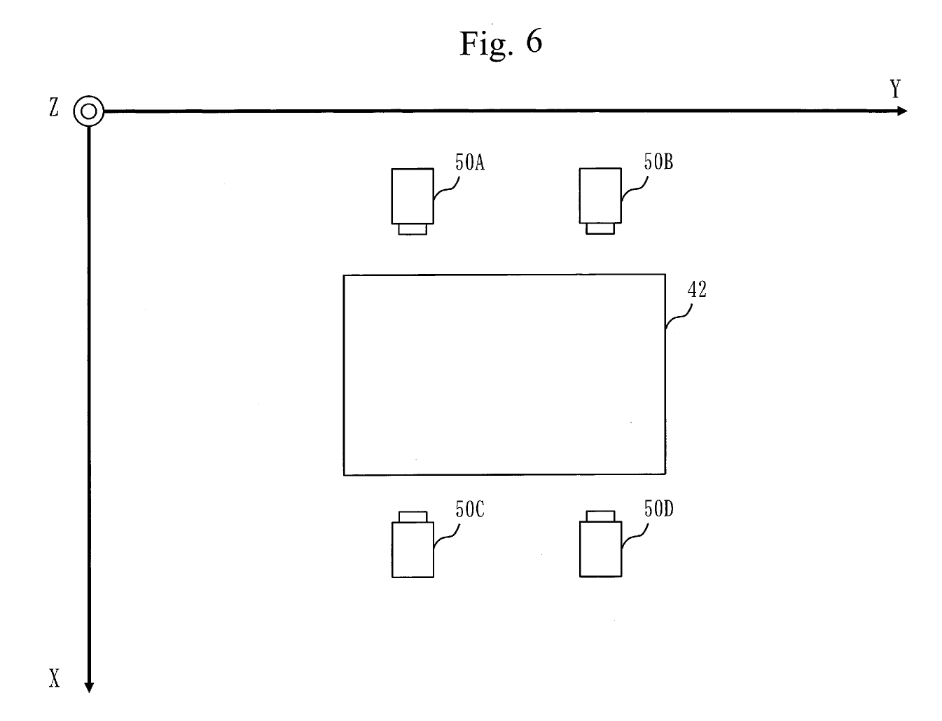

In the first embodiment, as illustrated in FIG. 6, assume that two cameras 50 are arranged to face each other along the x direction and two or more cameras 50 are arranged in parallel along the y direction at an installation height Zs. When two cameras 50 are arranged to face each other along the short-side direction of a rectangle representing the subject region 42 and two or more cameras 50 are arranged in parallel along the long-side direction of the rectangle, a video with little distortion can be obtained. Thus, in the first embodiment, the short-side direction of the rectangle representing the subject region 42 is the x direction while the long-side direction of the rectangle is the y direction.

The installation positions 45 specified in step S3 include installation positions X in the x direction parallel to an X axis, installation positions Y in the y direction parallel to a Y axis, installation positions Z in the z direction parallel to a Z axis, yaw attitudes that are rotation angles about the Z axis being a rotation axis, pitch attitudes that are rotation angles about the Y axis being a rotation axis, and roll attitudes that are rotation angles about the X axis being a rotation axis.

In the first embodiment, the installation positions Z of the respective cameras 50 are the installation height Zs included in the camera condition 41. In addition, the yaw attitudes are such that the x direction is defined as 0 degrees, and one of the two cameras 50 facing each other has a yaw attitude of 0 degrees while the other of the two cameras 50 has a yaw attitude of 180 degrees. In FIG. 6, cameras 50A and 50B have a yaw attitude of 0 degrees, and cameras 50C and 50D have a yaw attitude of 180 degrees. In addition, the cameras 50 have a roll attitude of 0 degrees.

Thus, in step S3, the remaining installation positions X, installation positions Y, and pitch attitudes are specified. The pitch attitudes will hereinafter be referred to as angles of depression α.

<Step S31: Position X Specifying Process>

The X position specifying unit 231 of the position specifying unit 23 specifies installation positions X and angles of depression α of two cameras 50 with which the entire subject region 42 in the x direction can be captured and with which at least the elongation ratio of a subject in front of the cameras 50 is equal to or lower than the critical elongation ratio K.

Specifically, the X position specifying unit 231 reads the subject region 42 received in step S1 and the camera condition 41 received in step S2 from the memory 121. The X position specifying unit 231 then determines a use range Hk* to be actually used within a coverage range H of the cameras 50 so that the use range Hk* is within a range Hk expressed by Expression 4 and satisfies Expression 6, which will be explained below. The X position specifying unit 231 then calculates the installation position X of one of the two cameras 50 facing each other by Expression 7, and calculates the installation position X of the other camera 50 by Expression 8. In addition, the X position specifying unit 231 determines an angle between an upper limit and a lower limit expressed by Mathematical Expressions 10 and 12 as an angle of depression α.

A method by which the X position specifying unit 231 specifies the installation positions X and the angles of depression α will be explained in detail.

As illustrated in FIG. 7, an offset O at the installation position Zs, the angle of view θ and the angle of depression α and the coverage range H of a camera 50 are expressed by Expression 1. The offset O is a distance from a position right below the camera 50 to a left end of a captured range.

O=Zs·tan(π/2−α−θ/2)

H=Zs·tan(π/2−α+θ/2)−O (Expression 1)

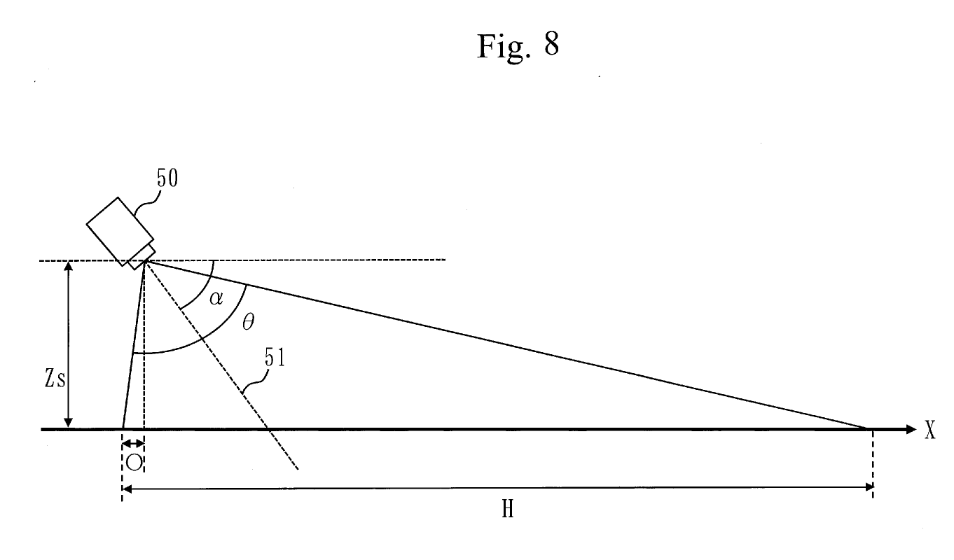

FIG. 7 illustrates a case in which the position right below the camera 50 cannot be captured. In a case where the position right below the camera 50 can be captured as illustrated in FIG. 8, the offset O and the coverage range H of the camera 50 are expressed by Expression 2.

O=Zs·tan(π/2+α+θ/2)

H=Zs·tan(π/2−α+θ/2)+O (Expression 2)

In the description below, the case where the camera 50 can capture the position right below is assumed and explained with use of Mathematical Expression 2. In the case where the camera 50 cannot capture the position right below, Mathematical Expression 1 is used instead of Mathematical Expression 2.

The subject region 42 has a width Wx in the x direction. Thus, in a case where the entire coverage area of two cameras 50 facing each other are to be used, the angle of depression α is obtained such that Wx=2H is satisfied. In a case where a tall subject is captured as illustrated in FIG. 9, however, the subject is elongated as a result of overhead-view conversion of videos in step S5. The elongation ratio of the subject is higher as the subject is farther from the optical axis 51 of the camera 50. When the elongation ratio is high, the video becomes hard to see.

When the height of the subject is not considered, a range Hk where the elongation ratio of the subject is equal to or lower than the critical elongation ratio K within the coverage range is expressed by Expression 3 using the critical elongation ratio K and the installation position Zs that is the installation height of the camera 50.

Hk=K·Zs (Expression 3)

Furthermore, when the height of the subject is considered, a range Hk where the elongation ratio of the subject not taller than the critical height Zh is equal to or lower than the critical elongation ratio K is expressed by Expression 4.

Hk=K(Zs−Zh) (Expression 4)

In addition, when the height of the subject is considered, the offset O and the coverage range H of the camera 50 is expressed by Expression 5.

O=(Zs−Zh)tan(π/2+α+θ/2)

H=(Zs−Zh)tan(π/2−α+θ/2)+O (Expression 5)

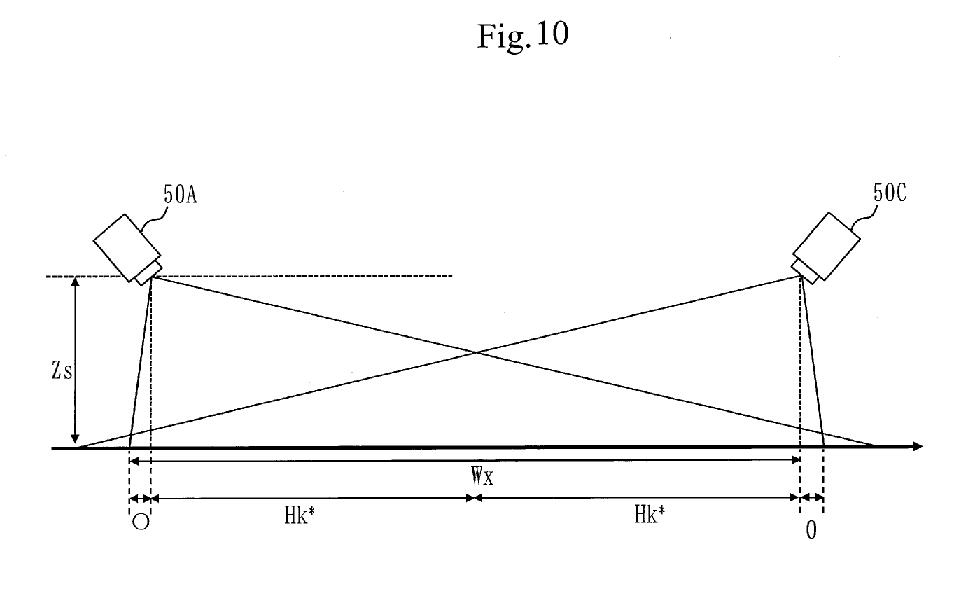

As illustrated in FIG. 10, in a case where two cameras 50 facing each other have an equal critical elongation ratio K, the X position specifying unit 231 determines a use range Hk* to be actually used within the coverage range H of the cameras 50 so that the use range Hk* is within the range Hk expressed by Expression 4 and satisfies Expression 6.

Wx<2Hk*+2O (Expression 6)

In this case, when the use range Hk* is determined so that the right side of Expression 6 is larger than the left side thereof to some extent, the two cameras 50 facing each other capture regions that partially overlap with each other. This allows a superimposing process such as a blending to be applied in combining videos, which makes the resulting video more seamless.

Specifically, the X position specifying unit 231 displays a range of values within the range Hk expressed by Expression 4 and satisfying Expression 6 on the display 32, and receives input of a use range Hk* within the displayed range from the user, to determine the use range Hk*. Alternatively, the X position specifying unit 231 determines a value with which an overlapping region captured by both of the two cameras 50 facing each other has a reference width as the use range Hk* from the values within the range Hk expressed by Expression 4 and satisfying Expression 6. The reference width is a width required for producing a certain effect by the superimposing process.

Note that, when a use range Hk* within the range expressed by Expression 4 and satisfying Expression 6 cannot be determined, this means that a region with an elongation ratio not higher than the critical elongation ratio and with a width Wx cannot be captured under the camera condition 41. Thus, in this case, since the position specifying unit 23 cannot specify the installation positions 45 in step S4, the position specifying unit 23 returns the processing to step S2. In step S2, the condition receiving unit 21 then receives input of a camera condition 41 in which information such as the installation height Zs or the critical elongation ratio K is changed.

The X position specifying unit 231 then calculates the installation position X₁ of one of the two cameras 50 facing each other by Expression 7, and calculates the installation position X₂ of the other camera 50 by Expression 8. In the case of FIG. 6, the X position specifying unit 231 calculates the installation position X₁ of the cameras 50A and 50B by Expression 7, and calculates the installation position X₂ of the cameras 50C and 50D by Expression 8.

X₁=x1+½Wx−Hk* (Expression 7)

X₂=x1+½Wx+Hk* (Expression 8)

The X position specifying unit 231 also specifies the angles of depression α.

Note that, since a coverage range needs to cover from right below the camera 50 to the use range Hk* in front of the camera 50, the angles of depression α satisfy Expression 9. An upper limit of the angles of depression α is defined by Expression 10 obtained from Expression 9.

(Zs−Zh)tan(π/2−α+θ/2)>Hk* (Expression 9)

α<(π+θ)/2−arctan(Hk*/(Zs−Zh)) (Expression 10)

In addition, since a coverage range needs to cover up to the position right below the camera 50, the angles of depression α satisfy Expression 11. A lower limit of the angles of depression α is defined by Expression 12 obtained from Expression 11.

(Zs−Zh)tan(π/2−α−θ/2)<(Wx/2−Hk*) (Expression 11)

α>(π−θ)/2−arctan(Wx/2−Hk*/(Zs−Zh)) (Expression 12)

The X position specifying unit 231 then determines an angle between the upper limit and the lower limit expressed by Mathematical Expressions 10 and 12 as an angle of depression α.

Specifically, the X position specifying unit 231 displays the upper limit and the lower limit expressed by Mathematical Expressions 10 and 12 on the display 32, and receives input of an angle of depression α between the displayed upper limit and lower limit from the user, to determine the angle of depression α. Alternatively, the X position specifying unit 231 determines a certain angle such as a median angle to be the angle of depression α among angles between the upper limit and the lower limit expressed by Mathematical Expressions 10 and 12.

Note that, in the description above, a case where not only a subject T near a boundary between cameras 50 facing each other but also subjects S and U behind the cameras 50 can be captured up to the critical height Zh as illustrated in FIG. 11 has been explained. As illustrated in FIG. 12, however, there are cases where subjects S and U on the near sides of the cameras 50 need not be captured up to the critical height Zh. In this case, a lower limit of the angles of depression α is defined by Expression 13.

α>(π−θ)/2−arctan(Wx/2−Hk*/Zs) (Expression 13)

<Step S32: Position Y Specifying Process>

The Y position specifying unit 232 of the position specifying unit 23 specifies installation positions Y with which the entire subject region 42 in the y direction can be captured.

Specifically, the Y position specifying unit 232 reads the subject region 42 received in step S1 and the camera condition 41 received in step S2 from the memory 121. The Y position specifying unit 232 then calculates the installation position Y of an M-th camera 50 from the coordinate value y1 in the y direction by using Expression 16 explained below.

A method by which the Y position specifying unit 232 specifies the installation position Y will be explained in detail.

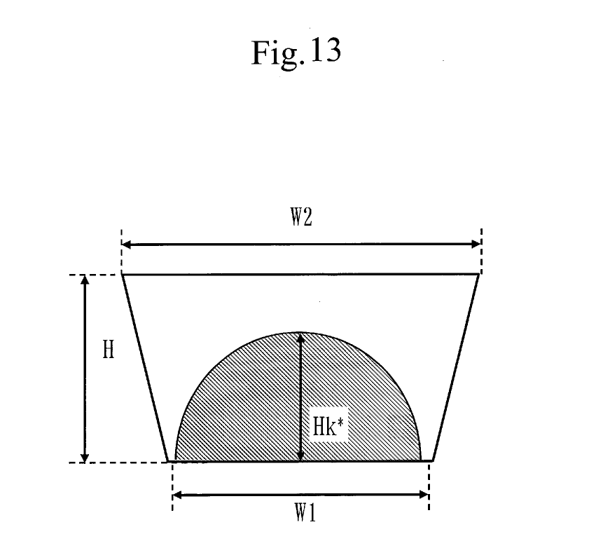

As illustrated in FIG. 13, a coverage range of each of the cameras 50 has a trapezoidal shape with a base on a back side of the camera 50 being a width W1, a base on a front side of the camera 50 being a width W2, and a height H as viewed from above. In addition, the trapezoidal shape includes a use region having a semicircular shape illustrated with hatching with a radius being the use range Hk* in which the elongation ratio is equal to or lower than the critical elongation ratio K.

When a ratio of a horizontal resolution and a vertical resolution of the camera 50 is represented by W_{θ}:H_{θ}, an aspect ratio of the trapezoid of the coverage range is expressed by Expression 14.

$$W 1 \text{:} H = {W}_{θ} \text{:} {H}_{θ} ( sin α + cos α / tan ( α - θ / 2 ) ) = sin ( α - θ / 2 ) \text{:} ( {H}_{θ} ( sin αsin ( α - θ / 2 ) + cos αcos ( α - θ / 2 ) ) ) {W}_{θ} = sin ( α - θ / 2 ) \text{:} ( {H}_{θ} cos ( θ / 2 ) ) / {W}_{θ} \qquad ( Expression 14 )$$

Thus, the base W1 is as expressed by Expression 15.

W1=((W_{θ} sin(α−θ/2))/(H_{θ} cos(θ/2)))H (Expression 15)

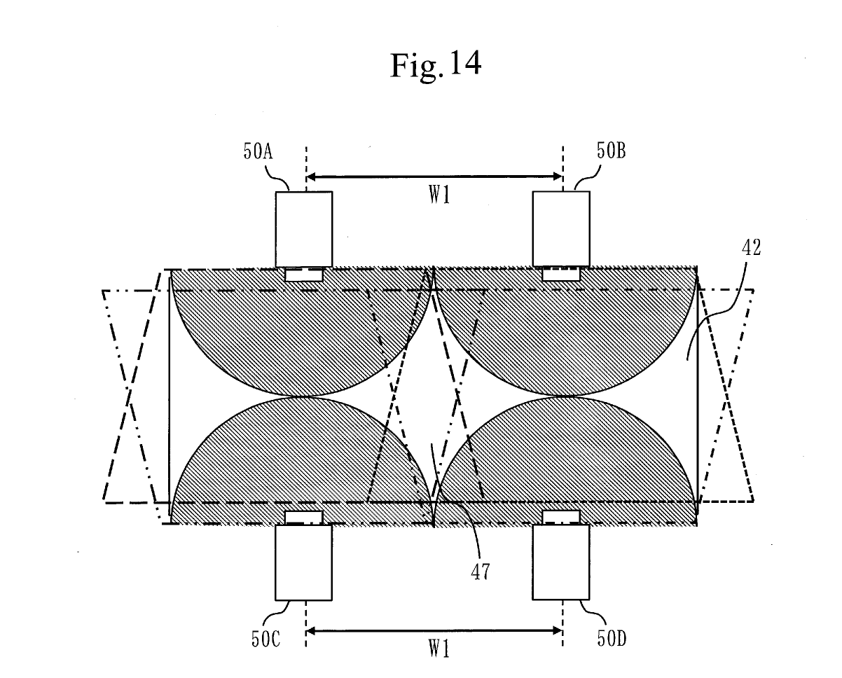

As illustrated in FIG. 14, the Y position specifying unit 232 arranges cameras 50 in parallel along the y direction with an interval of the width W1 between the cameras 50. Thus, the Y position specifying unit 232 calculates an installation position Y_{M} of the M-th camera 50 from the coordinate value y1 in the y direction by Expression 16.

Y_{M}=y1+((2M−1)W1)/2 (Expression 16)

In the case of FIG. 14, the Y position specifying unit 232 calculates the installation positions Y_{M} of the cameras 50A and 50C by Expression 17, and calculates the installation positions Y_{M} of the cameras 50B and 50D by Expression 18.

Y_{M}=y1+W½ (Expression 17)

Y_{M}=y1+(3·W1)/2 (Expression 18)

Note that, for capturing the entire width Wy with 2N cameras 50, 2N being the maximum number of cameras 50 indicated by the camera condition 41, NW1 obtained by multiplying the number N of cameras arranged in parallel along the y direction by the width W1 needs to be equal to or larger than the width Wy. Note that, although the number of cameras 50 is 2N, the number of cameras 50 arranged in parallel along the y direction is N since two cameras 50 are positioned to face each other along the x direction. When NW1 is not equal to or larger than the width Wy, the position specifying unit 23 cannot specify the installation positions 45, in step S4 and thus returns the processing to step S2. In step S2, the condition receiving unit 21 then receives input of a camera condition 41 in which information such as the maximum number 2N of cameras 50, the installation height Zs, or the critical elongation ratio K is changed.

In the description above, the installation positions Y with which the entire subject region 42 in the y direction can be captured are specified. In the y direction as well, however, similarly to the x direction, for making the elongation ratio of a subject be equal to or lower than the critical elongation ratio K, the Y position specifying unit 232 calculates the installation positions y by replacing W1 in Expression 16 with 2Hk*. In this case as well, when 2NHk* obtained by multiplying the number N of cameras installed in parallel along the y direction by 2Hk* is not equal to or larger than the width Wy, the position specifying unit 23 cannot specify the installation positions 45 in step S4, and thus returns the processing to step S2.

In this case as well, however, a region in which the elongation ratio is higher than the critical elongation ratio K may be present near the middle of the four cameras 50 or the like in the subject region 42, such as a region 47 illustrated in FIG. 14. The installation positions X and the installation positions Y can be adjusted such that the use regions of the respective cameras 50 in which the elongation ratio is equal to or lower than the critical elongation ratio K illustrated in FIG. 14 overlap with each other, so that the region in which the elongation ratio is higher the critical elongation ratio K is made smaller.

When N×W1 is sufficiently larger than the width Wy, the Y position specifying unit 232 can calculate the installation positions Y so that a range captured by the cameras 50 in an overlapping manner becomes larger. In this case, the number of regions that overlap among N cameras 50 is N−1. Thus, the Y position specifying unit 232 calculates a length L in the y direction of an overlapping region between cameras 50 by Expression 19.

L=(W1×N−Wy)/(N−1) (Expression 19)

The Y position specifying unit 232 then calculates the installation position Y_{M} of the M-th camera 50 by Expression 20 for each of the second and subsequent cameras 50 from the coordinate value y1 in the y direction. The installation position Y_{M} of the first camera 50 from the coordinate value y1 is calculated by Expression 16.

Y_{M}=y1+((2M−1)W1)/2−LM (Expression 20)

Note that, in the y direction as well, for making the elongation ratio of a subject be equal to or lower than the critical elongation ratio K, the Y position specifying unit 232 replaces W1 in Expressions 19 and 20 with 2Hk*.

Step S5 according to the first embodiment will be explained with reference to FIGS. 1, and 15 to 19.

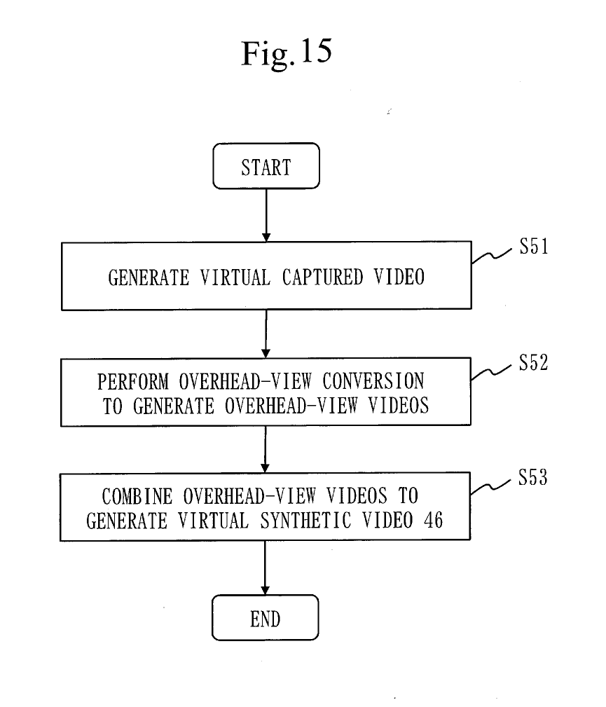

As illustrated in FIG. 15, step S5 is divided into steps S51 to S53.

<Step S51: Virtual Captured Video Generating Process>

The virtual video generating unit 24 generates virtual captured videos obtained by capturing the CG space 43 generated in step S1 with the cameras 50 in a case where the cameras 50 are installed at the installation positions 45 specified by the position specifying unit 23 in step S3.

Specifically, the virtual video generating unit 24 reads the CG space 43 generated in step S1 from the memory 121. The virtual video generating unit 24 then generates a video, as a virtual captured video for each of the cameras 50, obtained by capturing the CG space 43 in the direction of the optical axis 51 obtained from the orientation of the camera 50 as the center of point of view at the installation position 45 specified in step S3. The virtual video generating unit 24 writes the generated virtual captured videos into the memory 121.

<Step S52: Overhead-View Conversion Process>

The virtual video generating unit 24 performs overhead-view conversion on the virtual captured videos for the respective cameras 50 generated in step S51 to generate overhead-view videos.

Specifically, the virtual video generating unit 24 reads the virtual captured videos for the respective cameras 50 generated in step S51 from the memory 121. The virtual video generating unit 24 then uses homography conversion to project each of the virtual captured videos generated in step S51 from a capturing plane of each of the cameras 50 onto a plane where a coordinate value of the Z axis is 0.

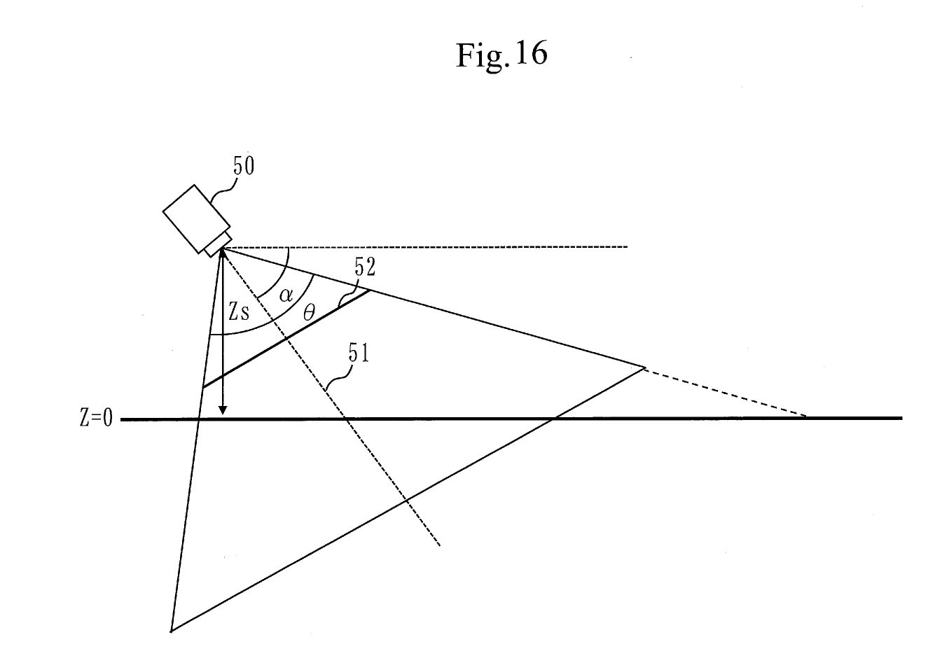

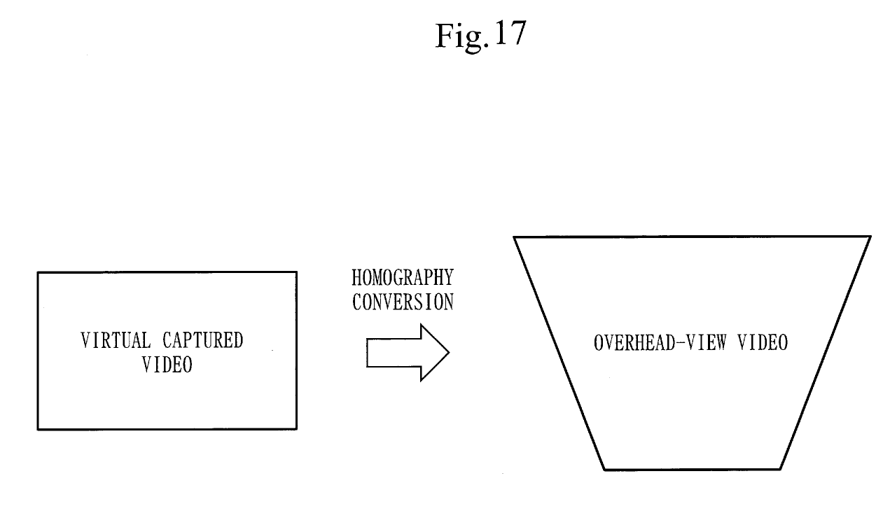

As illustrated in FIG. 16, a plane perpendicular to the optical axis 51 defined by the angle of depression α is the capturing plane 52, and the virtual captured video is a video on the capturing plane 52. As illustrated in FIG. 17, the virtual captured video is a rectangular video, but the virtual captured video projected on a plane where the coordinate value of the Z axis is 0 appears as a trapezoidal video. The trapezoidal video is an overhead-view video of the captured range of the camera 50. Thus, the virtual video generating unit 24 performs matrix transformation called homography conversion to convert the rectangular virtual captured video into trapezoidal overhead-view video. The virtual video generating unit 24 writes the generated overhead-view videos into the memory 121.

Note that the plane for projection is not limited to the plane where the coordinate value of the Z axis is 0 but may be a plane at any height. In addition, the shape of the projection plane is not limited to flat but may be curved.

<Step S53: Video Combining Process>

The virtual video generating unit 24 combines the overhead-view videos for the respective cameras 50 generated in step S52 to generate a virtual synthetic video 46.

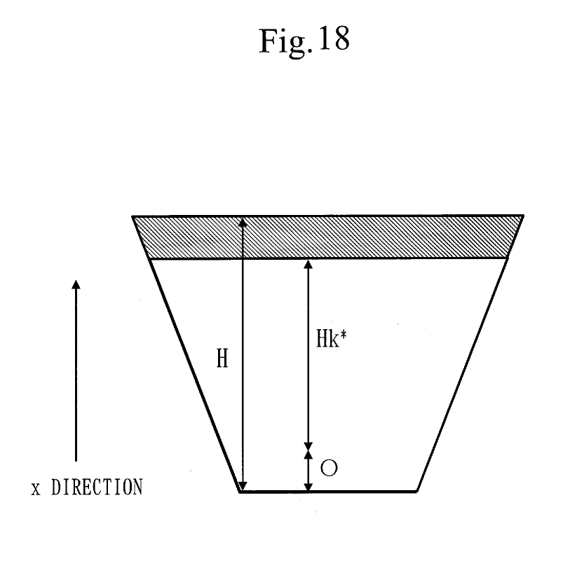

Specifically, the virtual video generating unit 24 reads the overhead-view videos for the respective cameras 50 generated in step S52 from the memory 121. As illustrated in FIG. 18, the virtual video generating unit 24 discards a part out of the use range Hk* in the x direction, that is, a part where the elongation ratio exceeds the critical elongation ratio K in each of the overhead-view videos. In other words, the virtual video generating unit 24 keeps a range of the use range Hk* from the installation position X forward in the x direction and a range of the offset O backward from the installation position X, and discards the remaining part. In FIG. 18, a hatched part is discarded. The virtual video generating unit 24 then performs a superimposing process such as α blending on overlapping parts of the remaining overhead-view videos of the respective cameras 50 to combine the overhead-view videos.

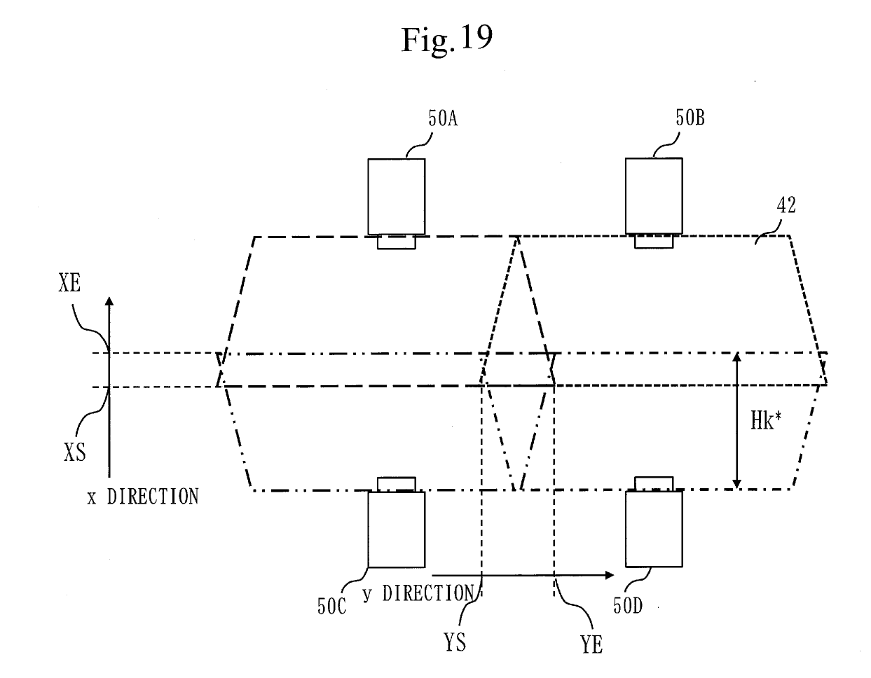

As illustrated in FIG. 19, for performing a blending on an overlapping part, the α value of the overhead-view video of the camera 50C is gradually decreased from 1 to 0 from X_{S} toward X_{E} in the x direction, and the a value of the overhead-view video of the camera 50A is gradually increased from 0 to 1 from X_{S} toward X_{E} in the x direction. X_{S} represents an x coordinate at a boundary of a captured region of the camera 50A in the x direction, and X_{E} represents an x coordinate at a boundary of a captured region of the camera 50C in the x direction. Similarly, for performing blending in the y direction, the a value of the overhead-view video of the camera 50C is gradually decreased from 1 to 0 from Y_{S} toward Y_{E}, and the a value of the overhead-view video of the camera 50D is gradually increased from 0 to 1 from Y_{S} toward Y_{E}. Y_{S} represents a y coordinate at a boundary of the captured region of the camera 50D on the side of the camera 50C in the y direction, and Y_{E} represents a y coordinate at a boundary of the captured region of the camera 50C on the side of the camera 50D in the y direction.

The virtual video generating unit 24 then extracts the part of the subject region 42 to be a virtual synthetic video 46 from the video resulting from combining. The virtual video generating unit 24 writes the generated virtual synthetic video 46 into the memory 121.

Note that, when no overlapping part is present, the superimposing process need not be performed, and the overhead-view videos are only arranged adjacent to one another so as to be combined.

In addition, when the installation positions Y are specified such that the elongation ratio is equal to or lower than the critical elongation ratio K, the virtual video generating unit 24 discards a part out of the use range Hk* in the y direction as well from each of the overhead-view videos before combining.

### Effects of the First Embodiment

As described above, the installation position determining device 10 according to the first embodiment specifies the installation positions 45 of cameras 50 at which a subject region 42 can be captured, the number of cameras 50 being equal to or smaller than a number indicated by a camera condition 41, and generates a virtual synthetic video 46 in a case where the cameras 50 are installed at the specified installation positions 45. This allows the user to determine the installation positions 45 of the cameras 50 at which a desired video can be obtained only by checking the virtual synthetic video 46 while changing the camera condition 41.

In particular, the installation position determining device 10 according to the first embodiment also takes the height of a subject into consideration, and specifies the installation positions 45 at which a subject not taller than the critical height Zh present in the subject region 42 can be captured. This eliminates such cases where the face of a person present in the subject region 42 cannot be captured from the specified installation positions 45.

In addition, the installation position determining device 10 according to the first embodiment also takes the elongation of a subject in overhead-view conversion into consideration, and specifies the installation positions 45 at which the elongation ratio of a subject is equal to or lower than the critical elongation ratio K. This eliminates such cases where the elongation ratio of a subject captured in a virtual synthetic video 46 is too high at the specified installation positions 45 and the virtual synthetic video 46 may be hard to see.

***Other Configurations***

<First Modification>

In the first embodiment, the functions of the respective units of the installation position determining device 10 are implemented by software. As a first modification, however, the functions of the respective units of the installation position determining device 10 may be implemented by hardware. The first modification will be described on differences from the first embodiment.

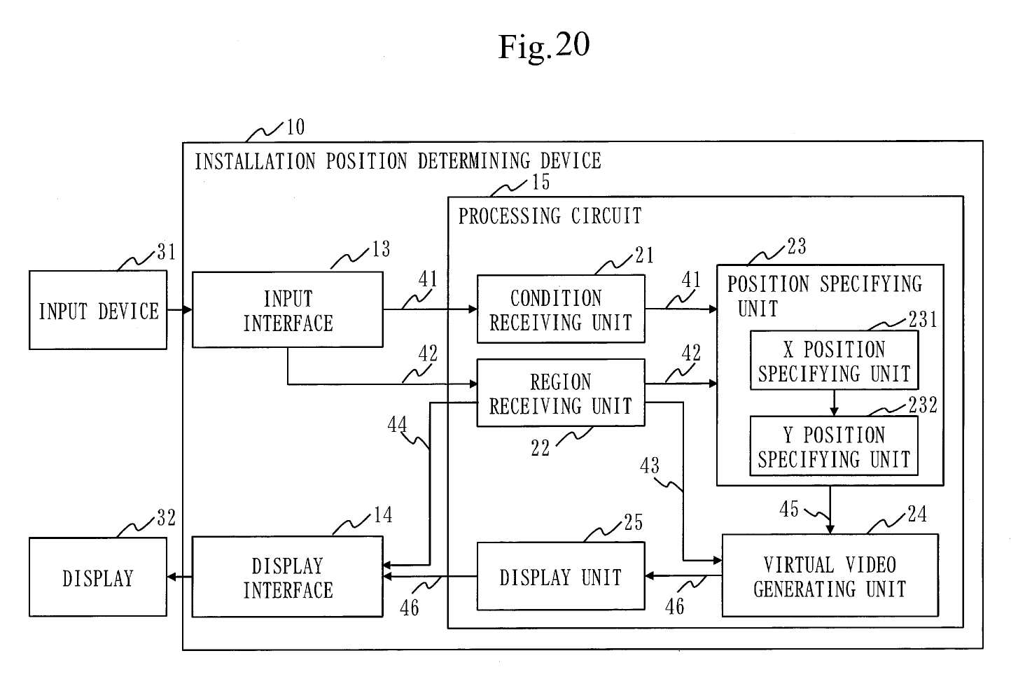

A configuration of the installation position determining device 10 according to the first modification will be described with reference to FIG. 20.

When the functions of the respective units are implemented by hardware, the installation position determining device 10 includes a processing circuit 15 instead of the processor 11 and the storage unit 12. The processing circuit 15 is a dedicated electronic circuit implementing the functions of the respective units of the installation position determining device 10 and the functions of the storage unit 12.

The processing circuit 15 is assumed to be a single circuit, a composite circuit, a programmed processor, a parallel-programmed processor, a logic IC, a gate array (GA), an application specific integrated circuit (ASIC), or a field-programmable gate array (FPGA).

The functions of the respective units may be implemented by one processing circuit 15 or may be distributed to a plurality of processing circuits 15.

<Second Modification>

As a second modification, some functions may be implemented by hardware and others may be implemented by software. More specifically, some functions of the respective units of the installation position determining device 10 may be implemented by hardware and other functions may be implemented by software.

The processor 11, the storage unit 12, and the processing circuit 15 are collectively referred to as “processing circuitry.” Thus, the functions of the respective units are implemented by the processing circuitry.

<Third Modification>

In the first embodiment, the subject region 42 is a rectangular region. The subject region 42, however, is not limited to a rectangle but may be a region of another shape. For example, the subject region 42 may be a circular region, or a region having a shape with a bent corner such as an L shape.

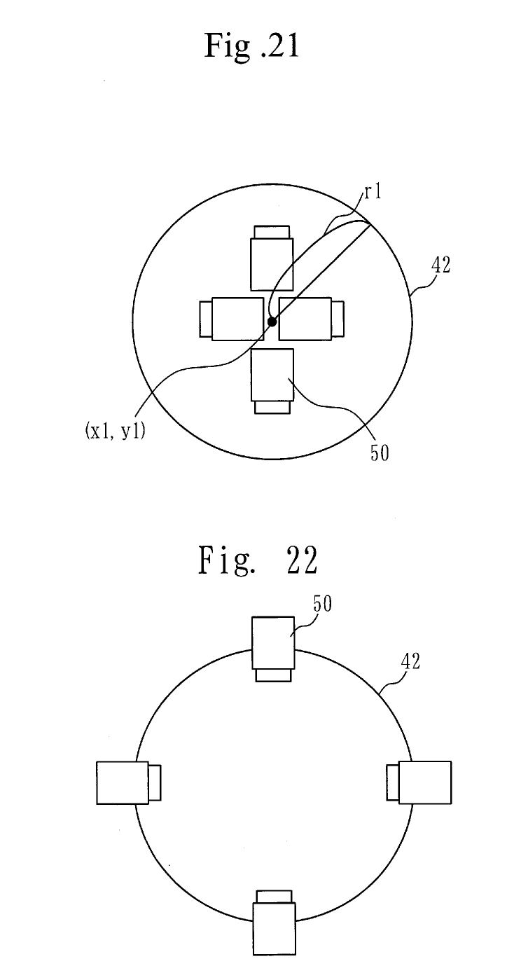

A case where the subject region 42 is a circular region will be described with reference to FIGS. 21 and 22.

As illustrated in FIG. 21, the subject region 42 is specified by the center position (x1, y1) of the region and the radius rl.

As illustrated in FIG. 21, a plurality of cameras 50 are arranged at the central position facing outward. Note that the central position refers to a region including the vicinity of the center and having a certain range. Alternatively, as illustrated in FIG. 22, a plurality of cameras 50 are arranged on the circumference of a circle at regular intervals facing toward the center. In addition, the heights and the like are of the cameras 50 are specified so that the cameras 50 can capture the subject region 42, the number of cameras 50 being a specified number.

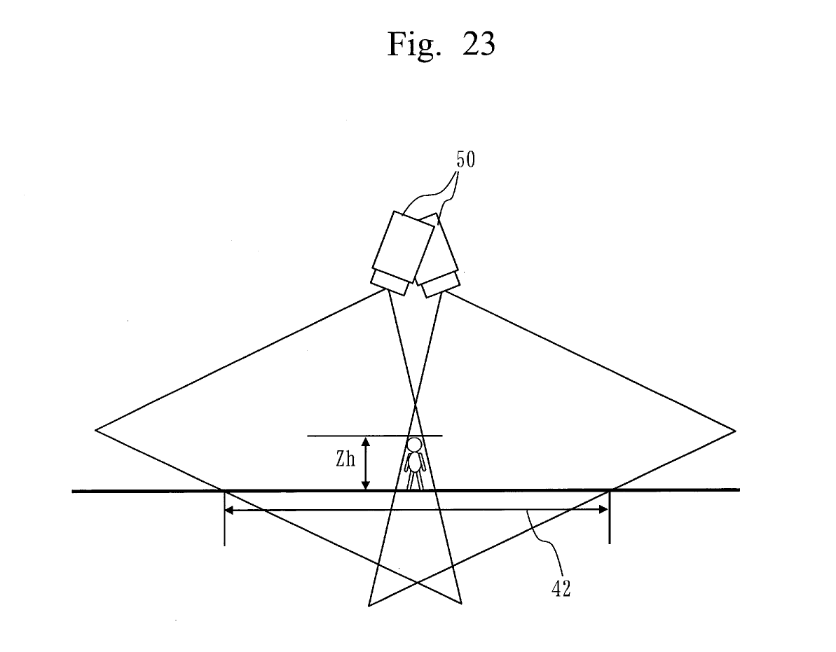

When the cameras 50 are arranged at the central position of the region as illustrated in FIG. 21, the angles of depression α are specified so that a subject at a critical height Zh present at the central position can be captured as illustrated in FIG. 23.

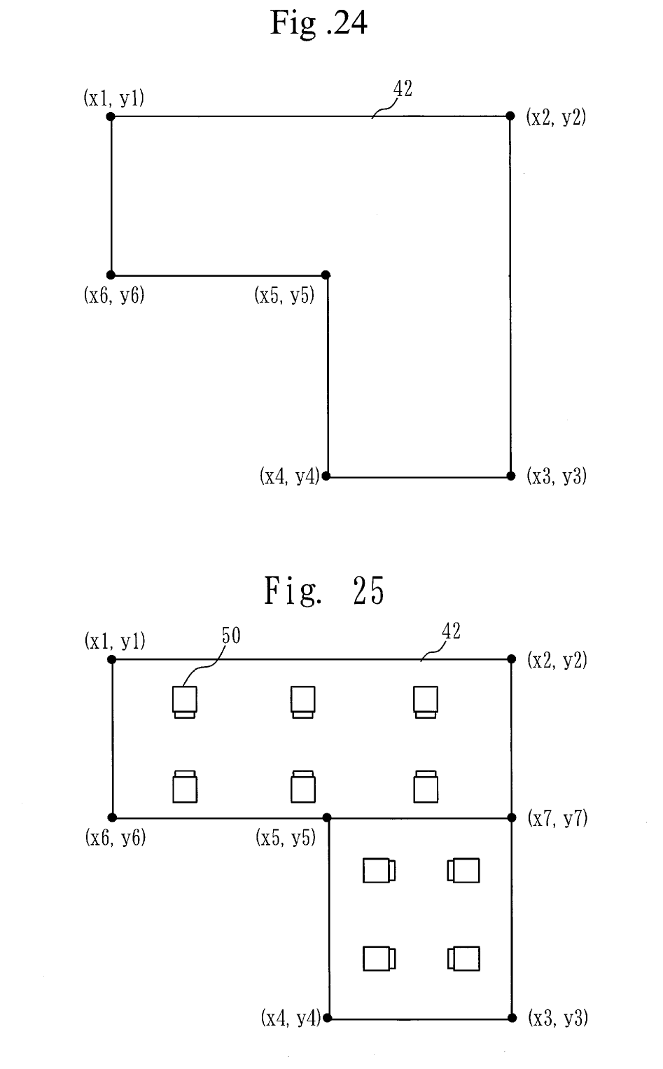

A case where the subject region 42 is a region of an L shape will be described with reference to FIGS. 24 and 25.

As illustrated in FIG. 24, the subject region 42 is specified by the positions (x1, y1), . . . , and (x6, y6) of the respective vertexes. Alternatively, the subject region 42 is specified by the positions of some of the vertexes and the distances between vertexes.

As illustrated in FIG. 25, the subject region 42 is then divided into a plurality of rectangular regions. In FIG. 25, the L-shaped subject region 42 is divided into two regions, which are a rectangular region expressed by (x1, y1), (x2, y2), (x7, y7), and (x6, y6) and a rectangular region expressed by (x5, y5), (x7, y7), (x3, y3), and (x4, y4). The installation positions of the cameras 50 in each of the rectangular regions are specified through the same procedures as in the first embodiment so that the rectangular regions can be captured.

<Fourth Modification>

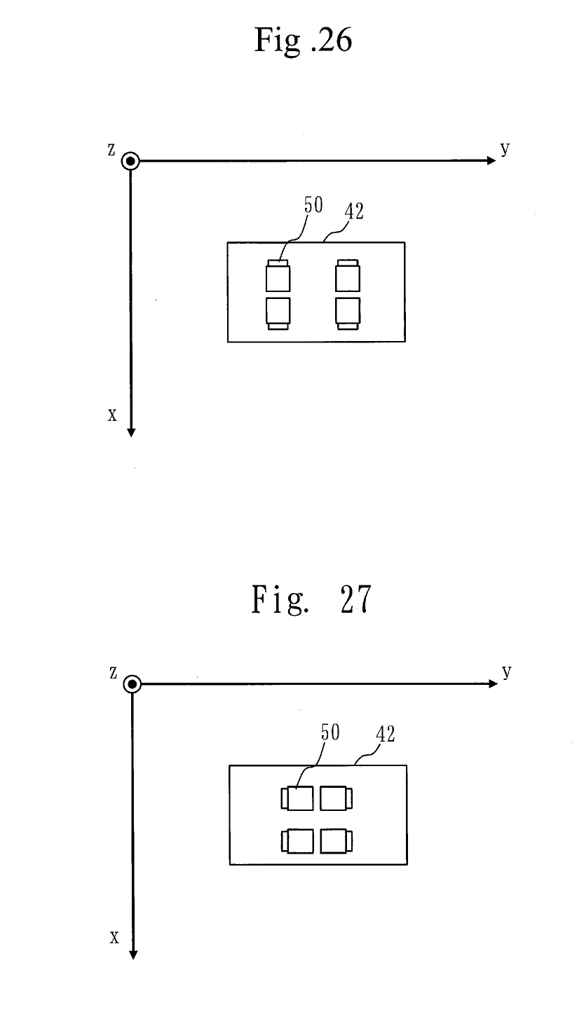

In the first embodiment, two cameras 50 are arranged to face each other along the short-side direction of a rectangle as illustrated in FIG. 6. Two cameras 50, however, may be arranged to face outward at the central position of a rectangle as illustrated in FIG. 26. In other words, two cameras 50 may be arranged back to back at the central position in the short-side direction of a rectangle. Alternatively, two cameras 50 may be arranged to face outward at the central position in the long-side direction of a rectangle as illustrated in FIG. 27. In other words, two cameras 50 may be arranged back to back at the central position in the long-side direction of a rectangle.

In this case, as illustrated in FIG. 23, the angles of depression α of the cameras 50 are specified so that a subject at a critical height Zh present right below the cameras 50, that is, at the central position in the short-side direction or the long-side direction can be captured.

The back-to-back arrangement of two cameras 50 at the central position allows a synthetic video with little distortion of a subject present at a boundary between two cameras 50 to be obtained.

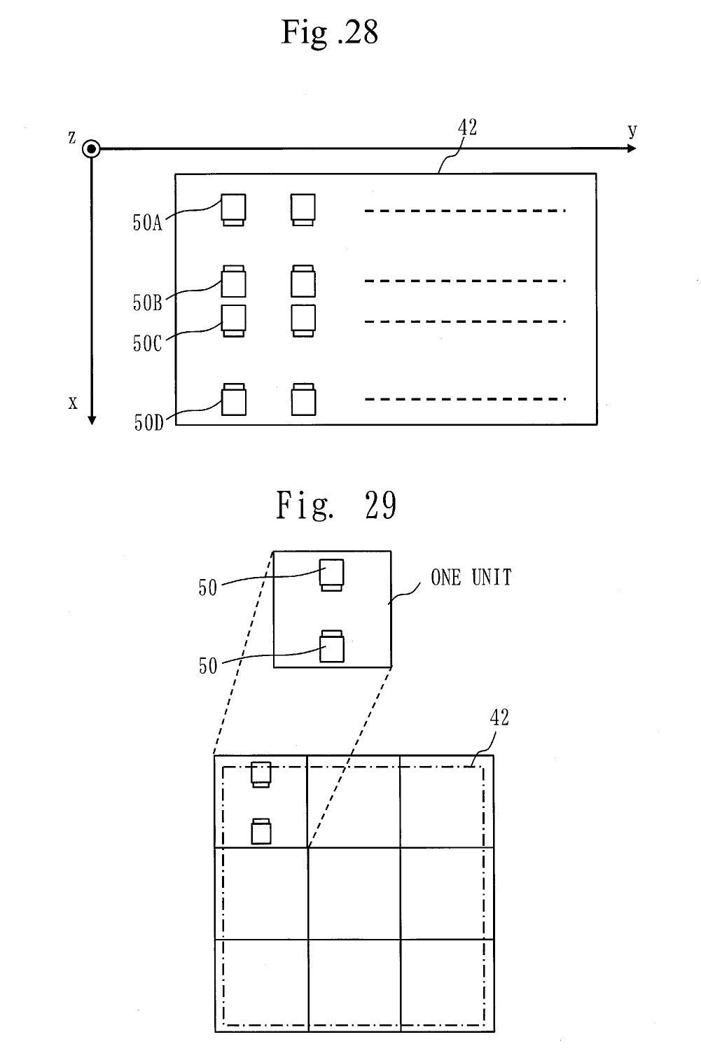

There are cases where a subject region 42 is so large that mere arrangement of two cameras 50 to face each other is not sufficient to capture the entire rectangle in the short-side direction. In such a case, face-to-face arrangement and back-to-back arrangement are combined as illustrated in FIG. 28. In FIG. 28, a camera 50A and a camera 50B face each other, the camera 50B and a camera 50C are arranged back to back, and the camera 50C and a camera 50D face each other. This allows the entire subject region 42 to be captured even when the rectangle is long in the short-side direction.

As illustrated in FIG. 29, for specifying installation positions of the cameras 50, each range that can be captured by two cameras 50 arranged to face each other is specified as one unit. The units specified in this manner are then arranged to cover the entire subject region 42, so that the number of necessary cameras 50 and the installation positions of the cameras 50 can be specified.

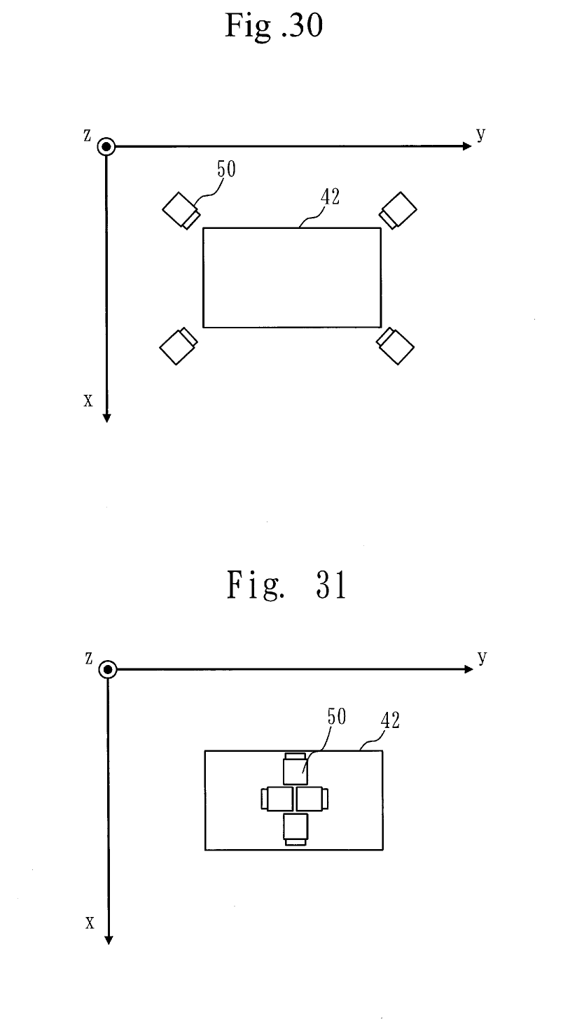

In addition, as illustrated in FIG. 30, cameras 50 may be arranged to face toward the center (in the diagonal directions) at the four corners of a rectangle. The places where cameras 50 can be installed are limited depending on the subject region 42, and there are cases where cameras 50 can only be installed outside of the subject region 42. The arrangement of cameras 50 at the four corners of a rectangle allows the entire subject region 42 to be efficiently captured from outside of the subject region 42.

In addition, as illustrated in FIG. 31, a plurality of cameras 50 may be arranged to face outward at the central position of a rectangle. The places where cameras 50 can be installed are limited depending on the subject region 42, and there are cases where cameras 50 have to be arranged at as small a number of positions as possible. For example, in a case where poles for cameras 50 are set up and the cameras 50 are installed on the poles, it is preferable that the number of poles be as small as possible. The arrangement of a plurality of cameras 50 to face outward at the central position of a rectangle allows cameras 50 to be arranged at one place and the entire subject region 42 to be efficiently captured.

<Fifth Modification>

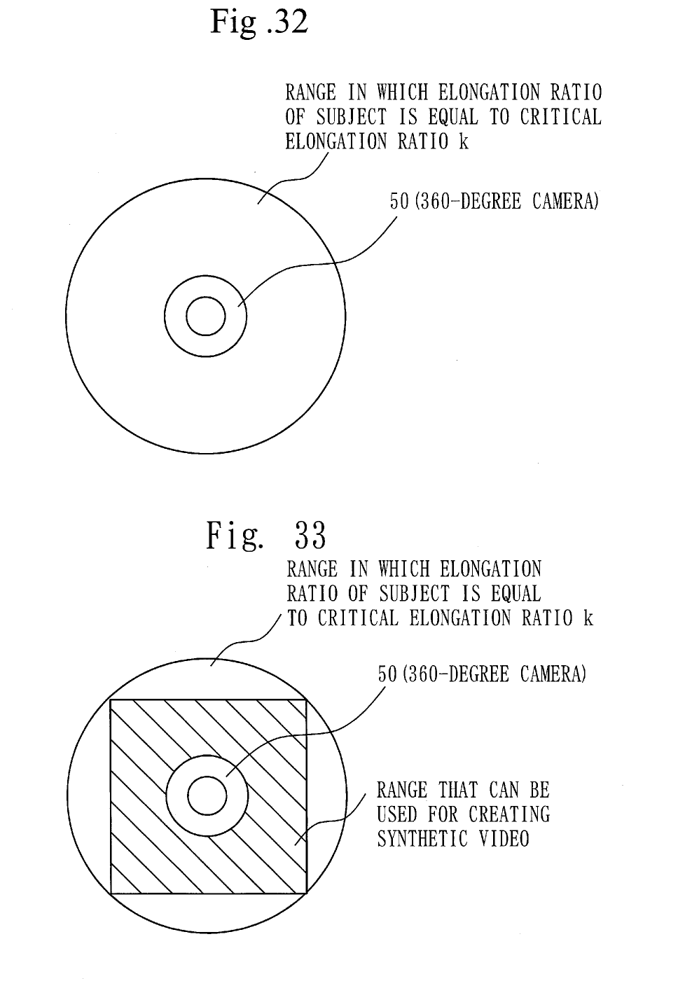

A 360-degree camera capable of capturing a range of 360 degrees around the camera may be used as a camera 50. In a case where a 360-degree camera is used as a camera 50, a circular region around the installation position of the camera 50 is a range in which the elongation ratio of a subject is equal to or lower than the critical elongation ratio K as illustrated in FIG. 32. In addition, the angle of depression α is the same as that in a case where the camera 50 is fixed at 90 degrees. The ratio of a horizontal resolution and a vertical resolution is 1:1.

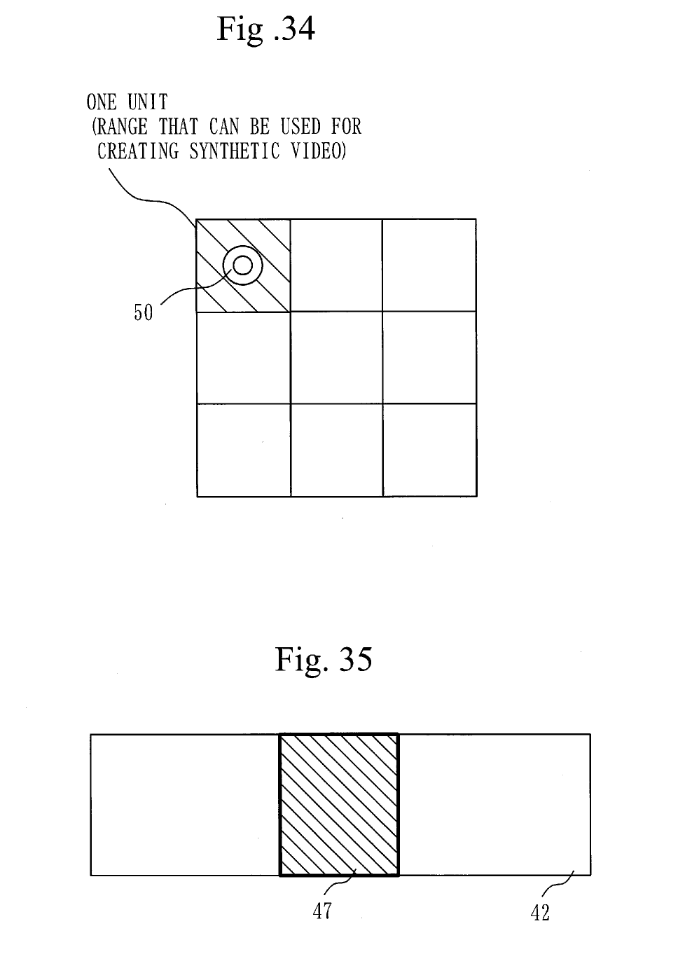

As illustrated in FIG. 33, when a video within a range in which the elongation ratio of a subject is equal to or lower than the critical elongation ratio K is used, a region used for generation of a synthetic video is a quadrangular region contained in a circular region representing the range in which the elongation ratio of a subject is equal to or lower than the critical elongation ratio K. Thus, as illustrated in FIG. 34, the quadrangular region is used as one unit, and the specified units are arranged to cover the entire subject region 42, so that the number of necessary cameras 50 and the installation positions of the cameras 50 can be specified.

### Second Embodiment

A second embodiment is different from the first embodiment in that a range in which cameras 50 cannot be installed is specified. In the second embodiment, the differences will be described and description of the features that are the same will not be repeated.

***Description of Operation***

In step S2 of FIG. 2, the condition receiving unit 21 receives input of a camera condition 41 indicating an unusable range 47 that is a range in which cameras 50 cannot be installed.

In a case where the unusable range 47 is rectangular, the unusable range 47 is specified by upper-left coordinate values (xi, yi), a width Wxi in the x direction parallel to the X axis, and a width Wyi in the y direction parallel to the Y axis. In a case where the unusable range 47 is circular, the unusable range 47 is specified by the coordinates (xi, yi) of the center and the radius ri of the circle. Note that the specification of the unusable range 47 is not limited thereto, and the unusable range 47 may be specified in another manner such as a formula. In addition, the unusable range 47 may have a shape other than a rectangle and a circle.

In step S3 of FIG. 2, the position specifying unit 23 first specifies installation positions 45 of cameras 50 capable of capturing the unusable range 47.

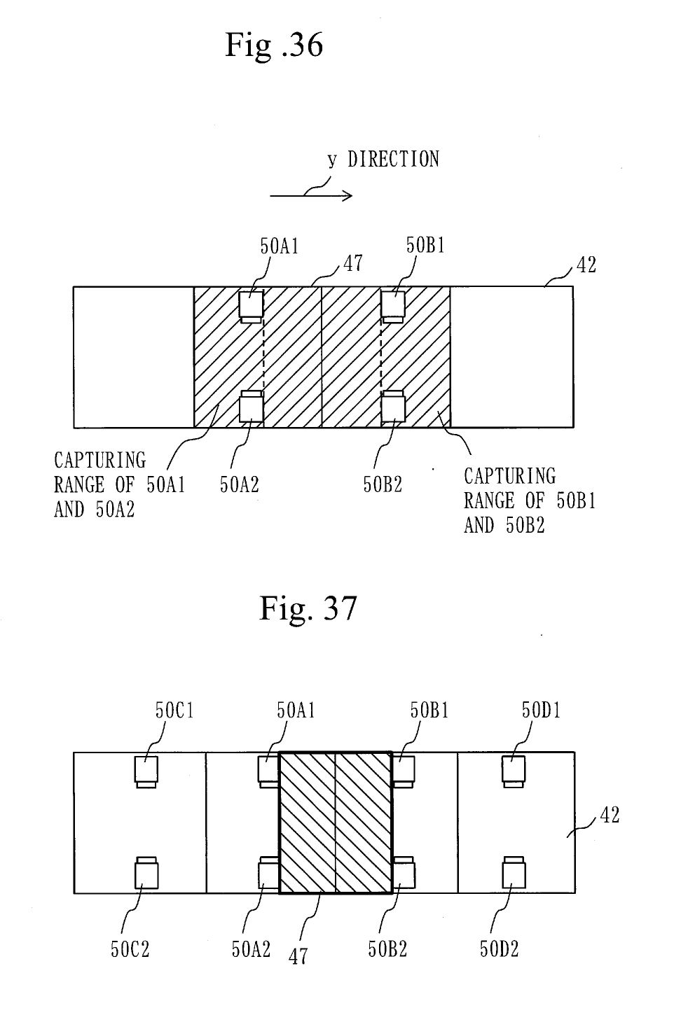

For example, as illustrated in FIG. 35, assume that a partial range in a rectangular subject region 42 is specified as an unusable range 47. In this case, as illustrated in FIG. 36, the installation positions 45 of the cameras 50 capable of capturing the unusable range 47, the installation positions 45 being outside of the unusable range 47, are specified.

In this process, the installation positions X and the angles of depression α are specified through the same process as in step S31 in FIG. 5. The installation positions Y are specified to be such positions where the entire unusable range 47 is just included in the coverage range of the cameras 50. In FIG. 36, the installation positions Y of cameras 50A1 and 50A2 and cameras 50B1 and 50B2 are specified so that a range on the left of a middle point in the y direction of the unusable range 47 is captured by the cameras 50A1 and 50A2 and that a range on the right of the middle point is captured by the cameras 50B1 and 50B2. More specifically, the installation position Y_{A} of the cameras 50A1 and 50A2 is specified by Expression 21, and the installation position Y_{B} of the cameras 50B1 and 50B2 is specified by Expression 22. Note that yh is a Y coordinate of the middle point.

Y_{A}=yh−W½ (Expression 21)

Y_{B}=yh+W½ (Expression 22)

Subsequently, the position specifying unit 23 specifies installation positions Y of the remaining cameras 50. The remaining cameras 50 are cameras 50C1 and 50C2 and cameras 50D1 and 50D2 in FIG. 37.

The position specifying unit 23 uses the previously specified installation positions Y of the cameras 50 for capturing the unusable range 47 as references for specification of the installation positions Y of the remaining cameras 50. In FIG. 37, an installation position Y_{M} for a range on the left of the unusable range 47 is specified by Expression 23 using the installation position Y_{A} of the cameras 50A1 and 50A2 as a reference. An installation position Y_{B} for a range on the right of the unusable range 47 is specified by Expression 24 using the installation position Y_{B} of the cameras 50B1 and 50B2 as a reference.

Y_{M}=Y_{A}−((2M−1)W½ (Expression 23)

Y_{M}=Y_{B}+((2M−1)W½ (Expression 24)

### Effects of the Second Embodiment

As described above, the installation position determining device 10 according to the second embodiment is capable of specifying the installation positions 45 of respective cameras 50 capable of capturing the subject region 42 when a range in which cameras 50 cannot be installed is specified.

Various equipment such as air conditioners and fire alarms is installed on ceilings of indoor facilities. Thus, there are places where cameras 50 cannot be installed. The installation position determining device 10 according to the second embodiment, however, allows appropriate installation positions 45 of cameras 50 to be determined avoiding the places where cameras 50 cannot be installed.

<Sixth Modification>

Cameras 50 cannot be installed in places without ceilings. A place without ceilings therefore corresponds to the unusable range 47. A mobile camera 53, however, which is a camera 50 mounted on a mobile object that flies such as a drone or a balloon may be used. When a mobile camera 53 can be flown, the mobile camera 53 can also be installed in a place without ceilings.

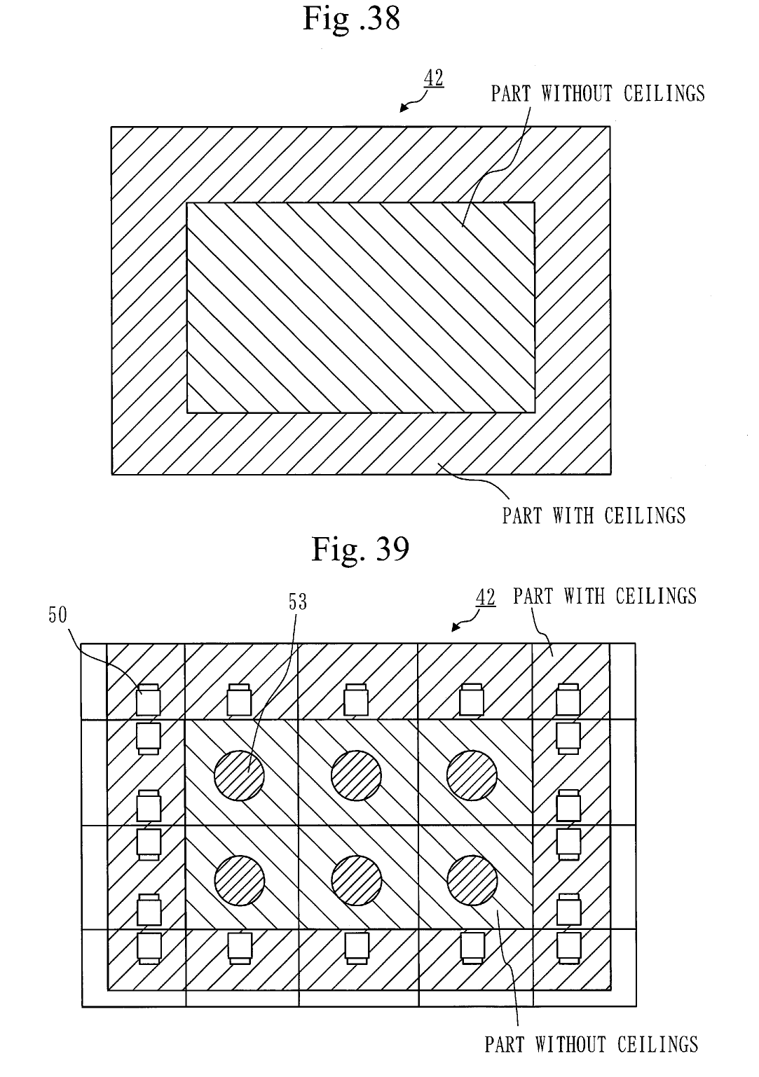

For example, mobile cameras 53 can be arranged in a place without ceilings in an outdoor stadium. In the case of an outdoor stadium, as illustrated in FIG. 38, the entire outdoor stadium corresponds to the subject region 42, and a middle part of the subject region 42 corresponds to a place without ceilings. In such a subject region 42 constituted by a part with ceilings and a part without ceilings, normal cameras 50 may be installed in the part with ceilings and mobile cameras 53 may be arranged in the part without ceilings. This allows the installation positions 45 of the cameras 50 and the mobile cameras 53 for generating an overhead-view video of the entire subject region 42 to be specified. Note that the heights at which the mobile cameras 53 fly are set to the installation positions Z of the cameras, and the installation positions 45 of the mobile cameras 53 can thus be specified in the same manner as those of the cameras 50.

The position specifying unit 23 thus specifies the installation positions 45 separately for the part with ceilings and the part without ceilings. As a result, the installation positions 45 of the normal cameras 50 and the mobile cameras 53 are specified as in FIG. 39 in the example of FIG. 38.

Use of the mobile cameras 53 allows arrangement of cameras in a place without ceilings. As a result, a video with high resolution can also be obtained for a place without ceilings.

### Third Embodiment

A third embodiment is different from the first and second embodiments in that a capturing range 55 of an existing camera 54 is specified. In the third embodiment, the differences will be described and description of the features that are the same will not be repeated.

***Description of Operation***

In step S2 of FIG. 2, the condition receiving unit 21 receives input of a camera condition 41 indicating a capturing range 55 of an existing camera 54.

The capturing range 55 of the existing camera 54 is specified in the same manner as the subject region 42. Specifically, in a case where the capturing range 55 of the existing camera 54 is rectangular, the capturing range 55 of the existing camera 54 is specified by upper-left coordinate values (xj, yj), a width Wxj in the x direction parallel to the X axis, and a width Wyj in the y direction parallel to the Y axis. In the third embodiment, the capturing range 55 of the existing camera 54 is rectangular.

In step S3 of FIG. 2, the position specifying unit 23 sets a region excluding the capturing range 55 of the existing camera 54 indicated by the camera condition 41 from the subject region 42 specified in step S1 of FIG. 2 to be a new subject region 42. The position specifying unit 23 then specifies the installation positions of the cameras 50 for the newly set subject region 42 by a method explained in the embodiments described above or the modifications described above.

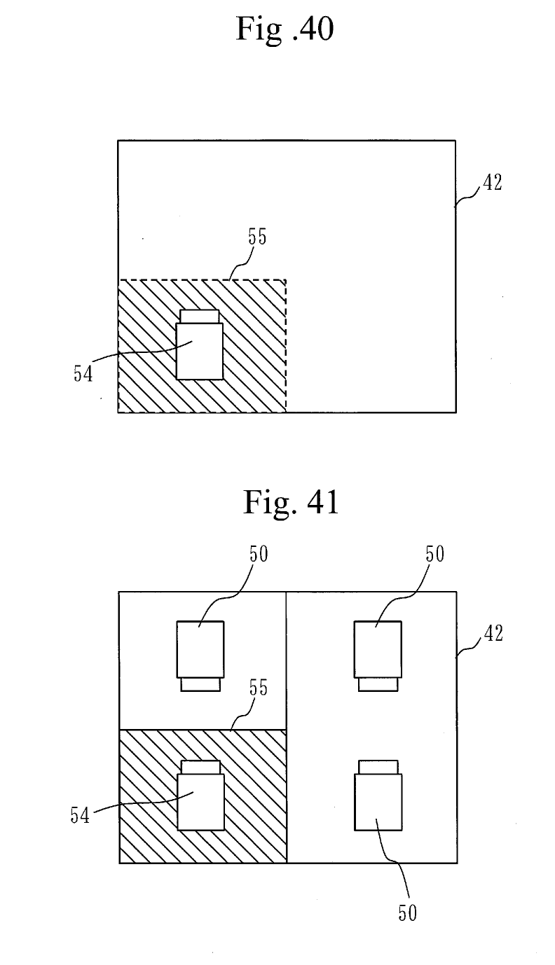

For example, as illustrated in FIG. 40, in a case where a range of a lower-left part of the subject region 42 is the capturing range 55 of the existing camera 54, the position specifying unit 23 sets an L-shaped region excluding the capturing range 55 of the existing camera 54 from the subject region 42 to be a new subject region 42. The position specifying unit 23 then specifies the installation positions of the cameras 50 for the L-shaped subject region 42 by the method explained in the third modification. As a result, the installation positions of three cameras 50 are specified as illustrated in FIG. 41, for example.

In step S5 of FIG. 2, the virtual video generating unit 24 generates virtual captured videos obtained by capturing a virtual model with the cameras 50 and the existing camera 54. The virtual video generating unit 24 then performs overhead-view conversion on the generated virtual captured videos and combines the converted virtual captured videos to generate a virtual synthetic video 46.

In the example of FIG. 41, the virtual video generating unit 24 generates virtual captured videos obtained by capturing a virtual model with the three cameras 50 and the existing camera 54, and generates a virtual synthetic video 46.

### Effects of the Third Embodiment

As described above, the installation position determining device 10 according to the third embodiment is capable of specifying the installation positions 45 of cameras 50 to be newly installed taking the existing camera 54 into consideration. This allows the installation positions 45 of the cameras 50 capable of capturing the entire subject region 42 to be specified without installing an unnecessarily large number of cameras 50 in a case where an existing camera 54 is present.

### REFERENCE SIGNS LIST

10: installation position determining device, 11: processor, 12: storage unit, 13: input interface, 14: display interface, 15: processing circuit, 21: condition receiving unit, 22: region receiving unit, 23: position specifying unit, 231: X position specifying unit, 232: Y position specifying unit, 24: virtual video generating unit, 25: display unit, 31: input device, 32: display, 41: camera condition, 42: subject region, 43: CG space, 44: top view, 45: installation position, 46: virtual synthetic video, 47: unusable range, 50: camera, 51: optical axis, 52: capturing plane, 53: mobile camera

1. An installation position determining device comprising:
processing circuitry to:
receive input of camera condition indicating capturing conditions of cameras;
specify installation positions of cameras at which a subject region can be captured according to the received camera condition; and
generate virtual captured videos obtained by capturing a virtual model with the cameras in a case where the cameras are installed at the specified installation positions, and perform overhead-view conversion on the generated virtual captured videos and combine the virtual captured videos to generate a virtual synthetic video.

2. The installation position determining device according to claim 1, wherein
the camera condition indicates the number of cameras, and
the processing circuitry specifies the installation positions of the cameras at which the cameras can capture the subject region; the number of cameras being indicated by the camera condition.

3. The installation position determining device according to claim 1, wherein
the camera condition indicates a critical height, and
the processing circuitry specifies the installation positions at which a subject not taller than the critical height present in the subject region can be captured.

4. The installation position determining device according to claim 3, wherein
the camera condition indicates a critical elongation ratio, and
the processing circuitry specifies the installation positions at which an elongation ratio of a subject not taller than the critical height present in front of a camera is equal to or lower than the critical elongation ratio when the virtual captured videos are subjected to overhead-view conversion.

5. The installation position determining device according to claim 4, wherein
the camera condition indicates an installation height and an angle of view, and
the processing circuitry:
specifies installation positions X and angles of depression of two cameras at which the entire subject region in an x direction can be captured and the elongation ratio of the subject in the x direction is equal to or lower than the critical elongation ratio when the two cameras are installed at the installation height and at the angle of view facing each other along the x direction; and
specifies installation positions Y in a y direction perpendicular to the x direction at which the entire subject region in the y direction can be captured when the cameras are installed at the specified angles of depression and at the installation positions X.

6. The installation position determining device according to claim 5, wherein
the processing circuitry specifies an installation position X1 of one of the two cameras by X1=x1±(½)Wx−Hk* and an installation position X2 of the other of the two cameras by X2=x1+(½)Wx+Hk* by using a coordinate x1 in the x direction of an end of the subject region, a width Wx in the x direction of the subject region, and a width Hk* in the x direction at which the elongation ratio of the subject is equal to or lower than the critical elongation ratio.

7. The installation position determining device according to claim 6, wherein
the processing circuitry specifies the angles of depression α satisfying (π+θ)/2−arctan(Hk*/(Z−Zh))>α or (π+θ)/2−arctan(Hk*/Z)>α, and α>(π−θ)/2−arctan((Wx/2−Hk*)/(Z−Zh)) by using the installation height Z, the critical height Zh, and the angle of view θ.

8. The installation position determining device according to claim 7, wherein
when a ratio of a horizontal resolution and a vertical resolution of each of the cameras is represented by W_{θ}:H_{θ} and the number of cameras arranged in the y direction is N, the processing circuitry obtains W1=((W_{θ} sin(α−θ/2))/H_{θ} cos(θ/2))H and specifies installation positions Yi in the y direction of the respective cameras where i=1, . . . , N by Yi=y1+(2i−1)/2)W1 by using a coordinate y1 of an end in they direction of the subject region and a coverage width H in the x direction of the cameras.

9. The installation position determining device according to claim 7, wherein
when the number of cameras arranged in the y direction is N, the processing circuitry specifies installation positions Yi in the y direction of the respective cameras where i=1, . . . , N by Yi=y1+((2i−1)/2)2Hk* by using a coordinate y1 of an end in the y direction of the subject region.

10. The installation position determining device according to claim 2, wherein
when the processing circuitry fails to specify the installation positions at which the subject region can be captured according to the number of cameras, the processing circuitry receives re-entry of the camera condition.

11. The installation position determining device according to claim 4, wherein
when the processing circuitry fails to specify the installation positions at which the elongation ratio is equal to or lower than the critical elongation ratio, the processing circuitry receives re-entry of the camera condition.

12. The installation position determining device according to claim 1, wherein
the camera condition indicates an unusable range in which cameras cannot be installed, and
the processing circuitry specifies installation positions of cameras at which the subject region can be captured within a range excluding the unusable range.

13. The installation position determining device according to claim 1, wherein
the camera condition indicates range information allowing a capturing range of an existing camera to be specified, and
the processing circuitry specifies installation positions of cameras at which a region excluding the capturing range indicated by the range information from the subject region can be captured.

14. The installation position determining device according to claim 13, wherein
the processing circuitry generates virtual captured videos obtained by capturing a virtual video with the cameras and the existing camera, and performs overhead-view conversion on the generated virtual captured videos and combines the virtual captured videos to generate a virtual synthetic video.

15. An installation position determining method comprising:
receiving input of a camera condition indicating capturing conditions of cameras;
specifying installation positions of cameras at which a subject region can be captured according to the received camera condition; and
generating virtual captured videos obtained by capturing a virtual model with the cameras in a case where the cameras are installed at the specified installation positions, and performing overhead-view conversion on the generated virtual captured videos and combining the virtual captured videos to generate a virtual synthetic video.

16. A non-transitory computer readable medium storing an installation position determining program causing a computer to execute:
a condition receiving process to receive input of a camera condition indicating capturing conditions of cameras;
a position specifying process to specify installation positions of cameras at which a subject region can be captured according to the camera condition received in the condition receiving process; and
a virtual video generating process to generate virtual captured videos obtained by capturing a virtual model with the cameras in a case where the cameras are installed at the installation positions specified in the position specifying process, and perform overhead-view conversion on the generated virtual captured videos and combine the virtual captured videos to generate a virtual synthetic video.
